(19) United States
(12) Patent Application Publication
(10) Pub. No.: US 2020/0051111 A1
(43) Pub. Date: Feb. 13, 2020

(54) ONE TOUCH UPDATE TO EQUITY REWARDS

(71) Applicant: Bumped, Inc., Portland, OR (US)

(72) Inventors: David Nelsen, Lake Oswego, OR (US); Philip Bryan Hagen, Portland, OR (US); Jeffrey Press, Portland, OR (US); Aaron Wirick, Portland, OR (US); Cameron Knight, Portland, OR (US); Jason Zeiber, Scappoose, OR (US)

(21) Appl. No.: 16/537,470

(22) Filed: Aug. 9, 2019

Related U.S. Application Data
(60) Provisional application No. 62/717,743, filed on Aug. 10, 2018.

(51) Int. Cl. G06Q 30/02; G06Q 40/06

(52) U.S. Cl. CPC G06Q 30/0216; G06Q 30/0226; G06Q 30/0202; G06Q 40/06

(57) ABSTRACT

Herein disclosed are systems and methods for automatically redistributing a user's accumulated rewards based on, in one example, a change in loyalty by the user. In one example, a method for redistributing accumulated rewards on a loyalty platform in a single click comprises displaying a selectable interface element on a user device, wherein the selectable interface element indicates an accumulated reward from a first business in a rewards account of the user on the loyalty platform, and at least a second business, responding to selection of the selectable interface element by purchasing an amount of shares of stock in the second business using the accumulated reward, and presenting a notification to the user indicating that redistribution of the accumulated reward has been performed. The disclosed systems and methods may enable a reduction in delays and user frustration associated with conventional approaches for rebalancing a portfolio of accumulated rewards.

### CROSS REFERENCE TO RELATED APPLICATIONS

The present application claims priority to U.S. Provisional Patent Application No. 62/717,743 titled “ONE TOUCH UPDATE TO EQUITY REWARDS,” and filed on Aug. 10, 2018. The entire contents of the above-identified application are hereby incorporated by reference for all purposes.

### FIELD

The present application relates to systems and methods for distributing equity rewards to users of a loyalty platform based on purchase behavior and automatically balancing equities responsive to switching loyalties between businesses, merchants, and/or brands.

### BACKGROUND AND SUMMARY

Conventional reward programs, such as mail-in rebates or reward points based programs, often fail to build user loyalty with a particular company in the long term. One reason for this failure is that one-time rewards, like a rebate, or a physical prize awarded after redeeming a certain number of accumulated points, do little to align the interests of the user with the interests of the rewarding company beyond a certain limited time frame. Another factor limiting the success of conventional reward programs to generate user loyalty is the effort required on the part of the user to record and/or submit proof of purchases which may be eligible for a reward, such as when a user is required to enter a code or other proof of purchase into an online account in order to receive credit/points for the purchase, or when a proof of purchase must be mailed-in in order to receive a rebate. Additionally, in points based rewards programs, points accrued often come with an expiration date or date when the points must be redeemed by, thereby placing an additional burden on the user to hurriedly redeem their points, further exacerbating the inability of such programs to maintain user loyalty over the long term. Points frequently have no real value outside the scope of a rewards program, and as such, mean little to customers in the grand scheme of their financial picture. Furthermore, rewards programs often have unrealistic goals requiring many dollars spent and points earned in order to earn a small reward.

A further issue with rewards programs arises when a user changes a loyalty to and/or from different businesses. For example, when switching loyalties from a rewards program of a first business to a rewards program of a second business, the user may attempt to sell equity (e.g., fractional and/or full stocks, fractional and/or full shares, etc.) in the first business and purchase equity in the second business in order to align equity holdings to the updated loyalties. However, the above-described switching may be time intensive and involve a large amount of tedious user input, which becomes more laborious with each increase in the number of business loyalties that are changed. A further complication of aligning a user's equity holdings with the user's current loyalties is that an amount of stock accumulated in businesses to which the user was previously loyal may comprise a fractional number of shares of stock, and further, the amount of shares of stock to be purchased in the business to which the user is currently loyal may comprise a fractional number of shares, therefore in order for the user to update held equity to reflect current loyalties the user may need to sell a fractional number of shares of stock, and/or buy a fractional number of shares of stock. Buying and selling in fractional numbers of shares may result in further cost and/or delay for the user, as conventionally, shares of stock are purchased and sold in integer quantities.

Furthermore, in order to fully redistribute accumulated equity rewards to reflect updated loyalties (that is, to), the user may calculate the value of the sale of equity from the old businesses (businesses associated with loyalty rewards programs in which the user was previously enrolled), calculate the amount of equity in the new businesses (businesses associated with loyalty rewards programs in which the user is newly enrolled) that can be purchased with the value of the sale of equity from the old businesses, and place a purchase order for the calculated amount of equity in the new businesses. In light of the time delays described above, the user risks not completing the purchase order if the price of equity for the new businesses changes (increases) from when the calculation was made. Further, the user risks having not completely invested available funds if the price of the equity for the new businesses changes (decreases) from when the calculation was made.

The inventors herein have developed systems and methods which may enable redistribution of a user's accumulated equity and monetary rewards based on a triggering event, such as a change in user loyalty. In one example, a user may readjust a portfolio of accumulated equity rewards based on a loyalty change by pushing a single button within an interface. For example, the disclosure describes a loyalty rewards platform that provides a one click button (e.g., via an application executed on a user device in communication with the loyalty rewards platform and/or associated loyalty rewards computing system) which, upon a triggering event (e.g., a change in one or more business loyalties), offers the user an option to automatically sell equity for a business to which the user is no longer loyal and purchase the corresponding value (e.g., dollar or fractional dollar) amount of equity in a business to which the user is newly loyal. In another example, the disclosure describes a loyalty rewards platform that provides a one click button which, upon a triggering event, offers the user an option to automatically redistribute an accumulated monetary reward amongst one or more businesses to which the user has an active loyalty selection/loyalty agreement by purchasing equity in the one or more businesses. In this way, the user is provided with an opportunity to align equity holdings to updated, or existing, loyalties with a single user input (e.g., click or other selection of an element on a graphical user interface). The single user input may trigger the loyalty rewards platform to automatically exchange data with systems governing the equity of the new and old businesses in order to reduce delays and avoid the issues described above (e.g., the issues of imbalances between sales of equity and purchases of equity that either results in the declining of the purchase of new equity due to lack of sufficient funds, or results in the incomplete investment of available funds). Further, the systems and methods disclosed herein support redistribution of fractional shares of stock, thus enabling a user to easily convert fractional holdings in a first business to fractional holdings in a second business, based on a change of loyalty from the first business to the second business, without additional input or manual calculation on the part of the user.

In a first example, the above issues are at least partly addressed by A method comprising: displaying a selectable interface element on a display of a user device, wherein the selectable interface element indicates an accumulated reward from a first business in a rewards account of a user on a loyalty platform, and a least a second business, responding to selection of the selectable interface element by purchasing a first amount of shares of stock in the second business using the accumulated reward from the first business, storing the first amount of shares of stock in the rewards account of the user on the loyalty platform and presenting a notification to the user indicating that redistribution of the accumulated reward has been performed. In this way, a user may redistribute accumulated rewards automatically in substantially a single click. In one example, the first business may comprise a business to which the user has an active loyalty selection, and the accumulated reward may comprise a reward earned via loyalty to a second business (the reward comprising either a monetary reward or an equity reward) to which the user was previously loyal. Thus, a user may redistribute accumulated rewards to reflect current loyalties, by using previously earned rewards, earned from one or more businesses to which the user is no longer loyal, to purchase equity in one or more businesses to which the user is currently loyal.

In a second example, the above issues are at least partly addressed by a computing system including a processor, a display, and a memory storing instructions executable by the processor to receive a request to change enrollment from a first equity rewards program associated with a first business to a second equity rewards program associated with a second business, remove the user from the first equity rewards program and enrolling the user in the second equity rewards program, present an interface element via a user interface displayed on a display, the interface element being selectable to request a rebalancing of equity in a loyalty rewards platform account of the user, and, responsive to receiving user input selecting the interface element, perform the rebalancing of equity by generating one or more sell orders for equity in the first business accrued by the user via the first equity rewards program, transmitting the one or more sell orders to an order management system for execution, upon execution of the one or more sell orders, determining proceeds of an associated sale of the equity in the first business, calculating an amount of equity in the second business corresponding to the proceeds of the sale of the equity in the first business, generating buy orders for the calculated amount of equity in the second business, and presenting a notification to the user that the rebalancing of equity in the loyalty rewards platform account has been performed.

The above summary is provided to introduce a selection of concepts in a simplified form that are further described below in the Detailed Description. This summary is not intended to identify key features or essential features of the subject matter, nor is it intended to be used to limit the scope of the subject matter. Furthermore, the subject matter is not limited to implementations that solve any or all of the disadvantages noted above or in any part of this disclosure.

### BRIEF DESCRIPTION OF THE DRAWINGS

FIG. 1A shows an example of a loyalty platform.

FIG. 1B shows an example of a computing system implementing the loyalty platform.

FIGS. 2A, 2B, and 2C show a flowchart representing an example transaction process.

FIG. 3 shows an example equity allocation system of the loyalty platform.

FIG. 4 shows a flowchart of an example method for switching loyalty in order to receive equity rewards from different businesses.

FIGS. 5A and 5B show example graphical user interfaces for presenting options to switch loyalty and receive equity rewards from different businesses.

FIG. 6 shows an example timeline for distributing fractional equity rewards to users of the loyalty platform.

FIGS. 7A, 7B, and 7C show example graphical user interfaces for presenting options to redistribute accumulated cash rewards.

### DETAILED DESCRIPTION

The following description relates to systems and methods for a loyalty platform, such as a loyalty platform that provides equity rewards and/or fractional equity rewards to users based on tracked user loyalty purchases (the term “user” or “users” is herein used interchangeably with the terms “customer” or “customers”). Examples of loyalty platforms and related features are disclosed in U.S. Provisional Patent Application No. 62/697,284, entitled “DISTRIBUTING SUCCESS-LINKED REWARDS TO CUSTOMERS OF PRIVATELY HELD COMPANIES,” filed on Jul. 12, 2018, and U.S. Provisional Patent Application No. 62/543,884, entitled “DETERMINING EQUITY REWARDS BASED UPON PURCHASE BEHAVIOR”, filed on Aug. 10, 2017. The entire contents of each of the above-identified applications are hereby incorporated by reference for all purposes. The fractional equity rewards may comprise amounts of fractional shares of stock. As used herein, the terms fractional equity rewards, fractional shares of stock, fractional equity, fractional shares, fractional amounts of stock, fractional amounts of an Exchange Traded Fund (ETF), and similar terms shall be used interchangeably, and shall be understood to refer to positive, non-zero, non-integer amounts of shares of stock. For example, the term fractional shares of stock may refer to amounts of stock such as 1.2 shares, 0.00040 shares, 0.017397 shares, 23.7 shares, and irrational amounts of shares of stock such as pi shares, or e shares. In some examples the stock may be publicly traded, and in other examples the stock may be non-publicly traded. The fractional equity reward may be provided to a user by the loyalty platform based on a tracked user loyalty purchase made at a business, wherein the business has a Merchant Agreement with the loyalty platform to provide loyalty customers of said business with rewards of equity on behalf of the business, and wherein a user loyalty purchase may comprise a purchase made by a user at a business to which the user has made a loyalty selection.

As an example, the loyalty platform may have an agreement with STARBUCKS to reward loyalty customers of STARBUCKS with fractional shares of STARBUCKS stock based on purchases made by these loyalty customers. The term loyalty customer(s) as used herein (with reference to a business, company, or brand) refers to customers who have made an exclusionary loyalty selection to a brand (in this example, to STARBUCKS), wherein the loyalty selection may exclude the customer from receiving rewards from competing brands (competing brands may comprise brands offering similar products, or brands which operate in a same market, wherein a market is a brand category defined by the loyalty platform). As an example, STARBUCKS may reward loyalty customers with fractional shares of STARBUCKS stock in an amount of 2% of a monetary value of customer purchases, so, based on a customer with a loyalty selection to STARBUCKS conducting a purchase at STARBUCKS with a monetary value of $50.00, that customer may be eligible to receive $1.00 worth of STARBUCKS stock via the loyalty platform. With a current share price of STARBUCKS being $52.15/share, the loyalty customer in the above example may receive a fractional share of STARBUCKS in the amount of 0.01917 shares STARBUCKS. In examples where stock for a given business is not publicly traded, a non-stock asset, such as a crypto asset, may be provided in a similar manner to the stocks described above. For example, a crypto asset (or a number of crypto assets) that has a value tied to a revenue of the associated business may be provided to a user as a reward, where the monetary value of a unit of the crypto asset may vary with a revenue or other valuation of the business.

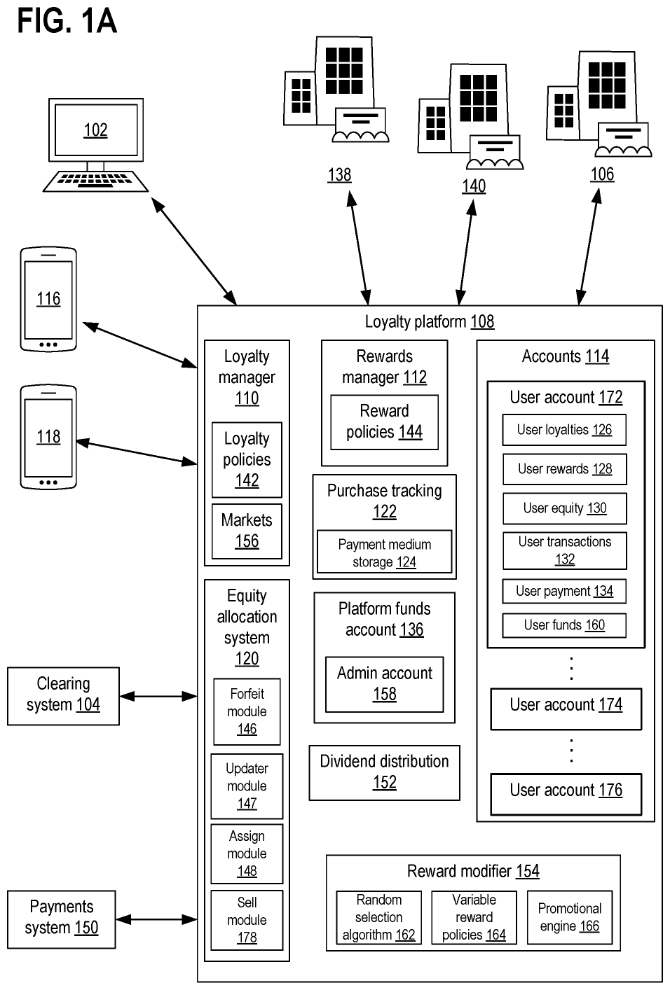

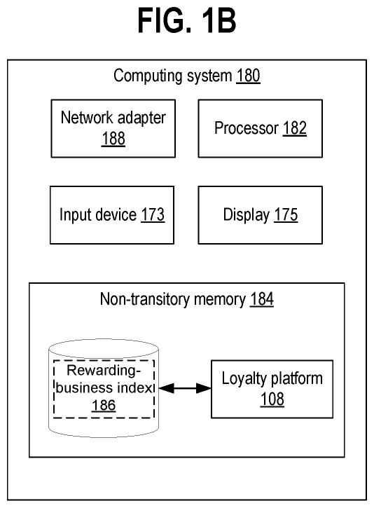

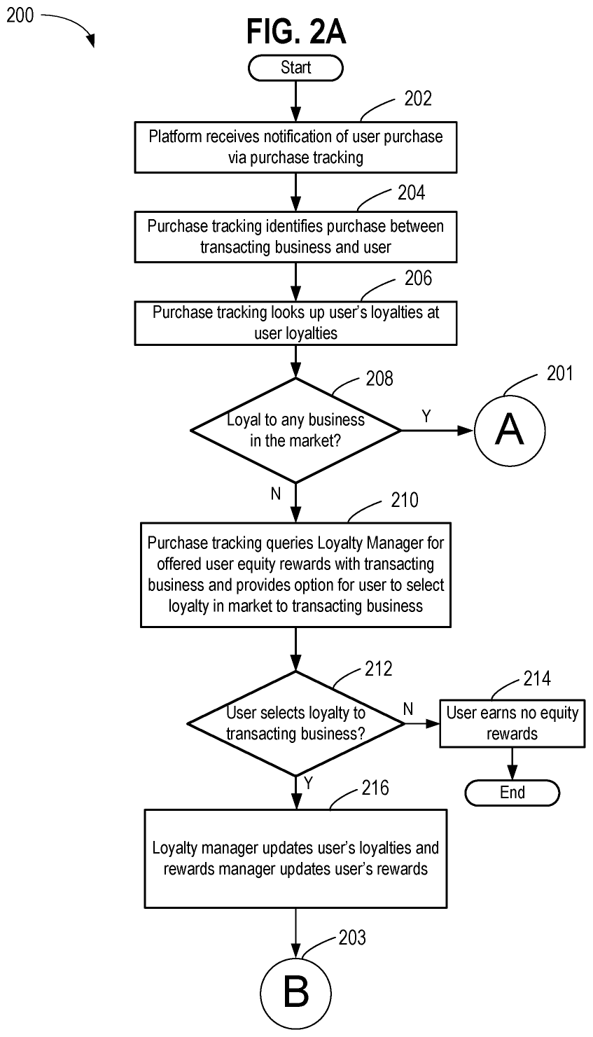

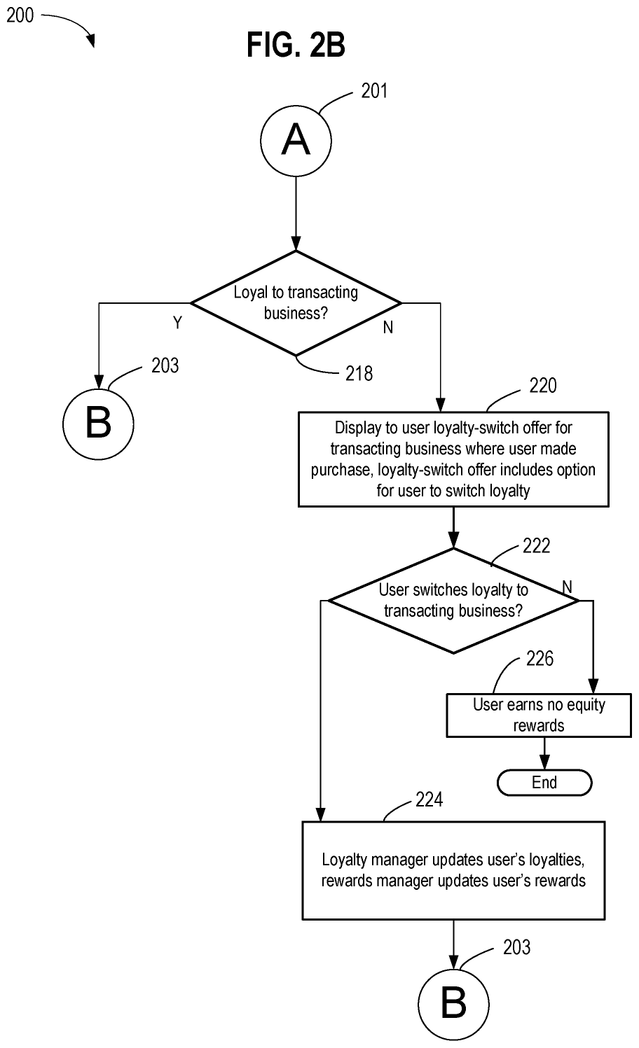

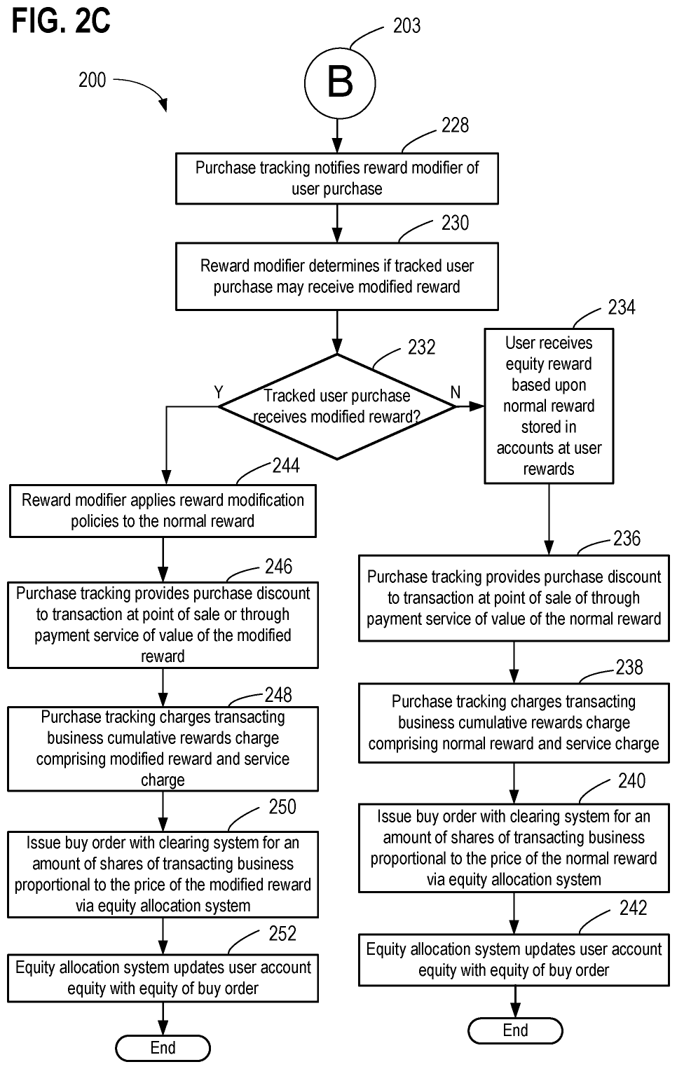

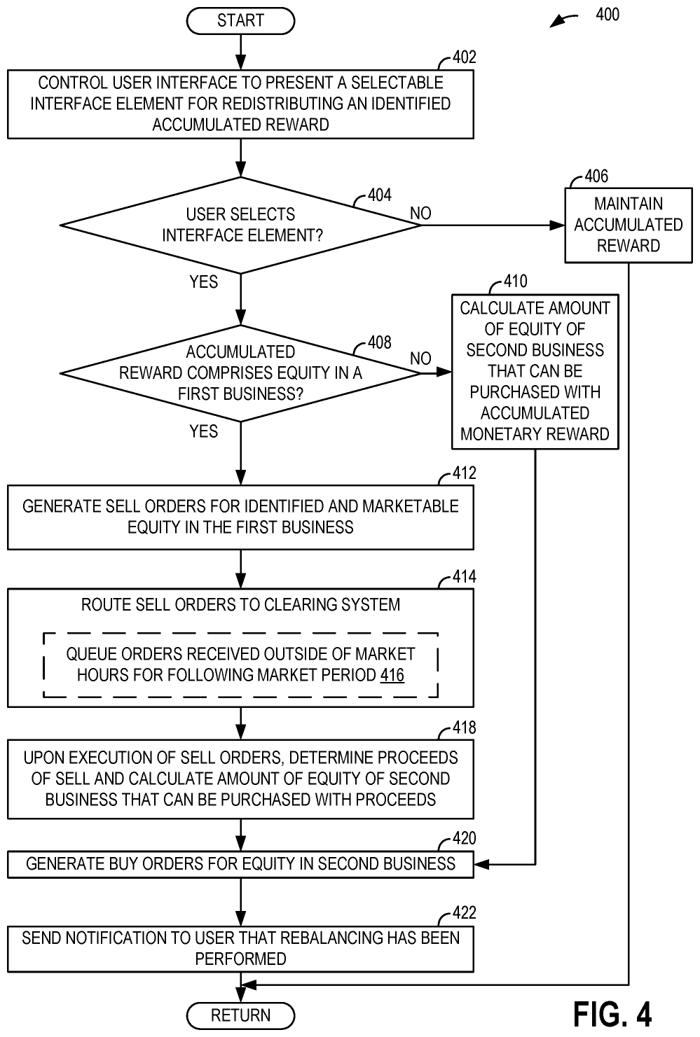

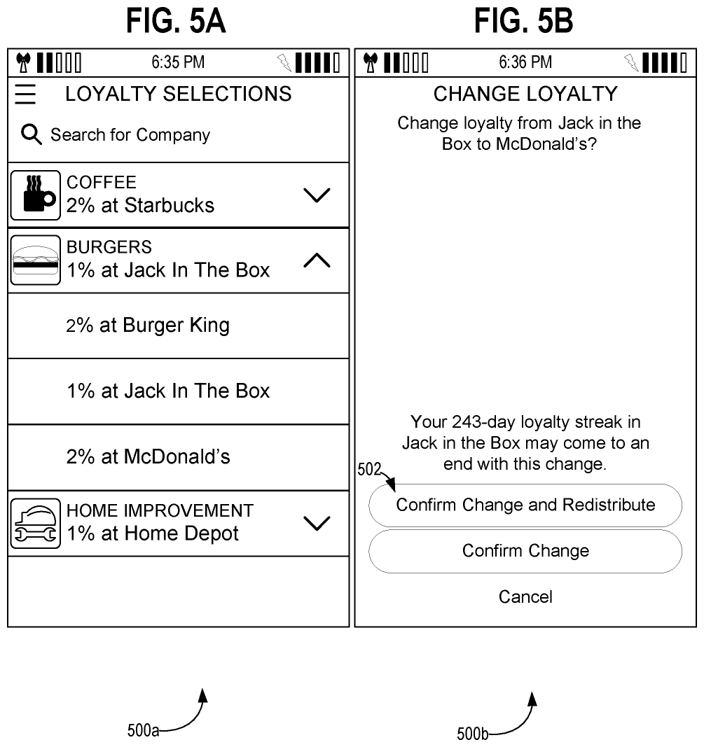

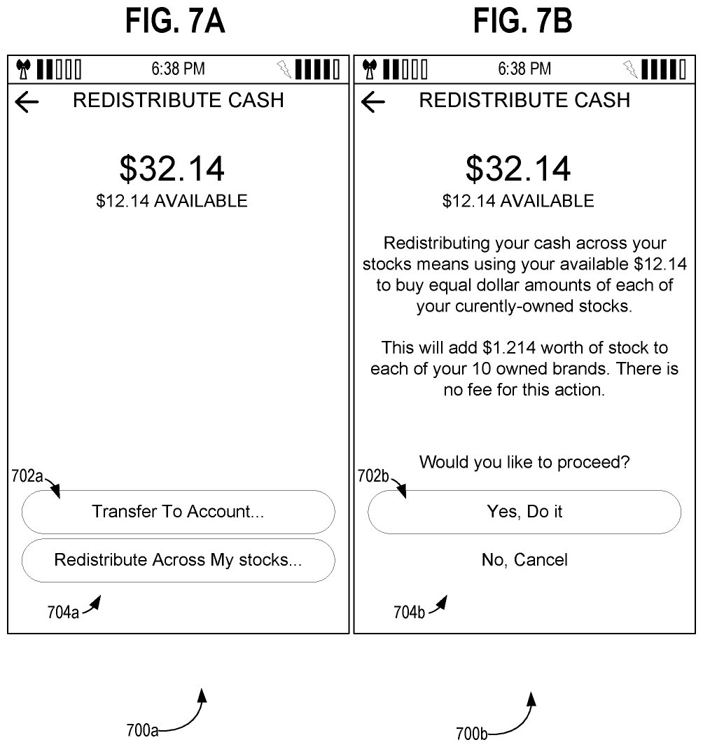

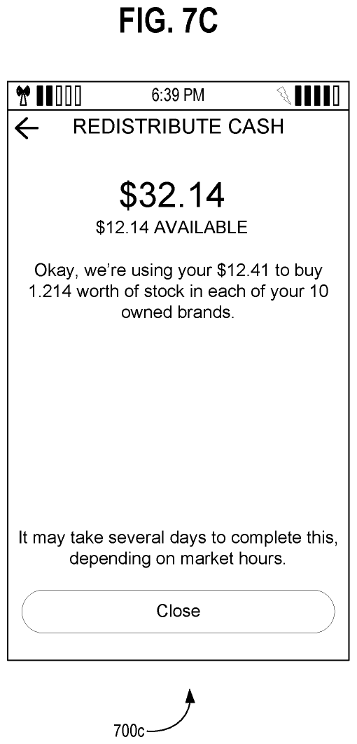

The following description provides examples of systems and methods which may enable a loyalty platform, such as loyalty platform 108 shown in FIG. 1A, to automatically rebalance/redistribute equity, or other accumulated rewards, in different companies responsive to a user request to switch between loyalty rewards programs for different businesses. The loyalty platform may be implemented by one or more computing systems, such as computing system 180 shown in FIG. 1B. Computing system 180 may include non-transitory memory 184, which may include instructions that when executed carry out one or more steps of one or more of the methods herein disclosed, such as methods 200 and 400 described in detail below with respect to FIGS. 2A, 2B, 2C, and 4. It will be understood that loyalty platforms, such as loyalty platform 108 may be implemented by more than one computing system, such as in a distributed computing scheme, wherein various functionalities of the loyalty platform may be enabled by a plurality of networked computing systems working in concert. Loyalty platform 108 may comprise an equity allocation system 120, which may distribute fractional shares of stock to users based on tracked user loyalty purchases. It is to be understood that loyalty platform 108 is a non-limiting example of a loyalty platform used in the methods and systems described in FIGS. 2A-4 and 6. FIGS. 5A, 5B, 7A, 7B, and 7C show example graphical user interfaces, which may be displayed by loyalty platform 108 to a user via a display of a user device. The graphical user interfaces of FIGS. 5A, 5B, 7A, 7B, and 7C may be displayed by a loyalty platform, such as loyalty platform 108, upon execution of one or more steps of methods 200 and/or 400 included herein.

FIG. 1A schematically shows an example loyalty platform 108. Loyalty platform 108 may be implemented by one or more computing systems. In one example, loyalty platform 108 may be implemented by a server. In another example, loyalty platform 108 may be implemented by a plurality of computing systems working in concert, such as through a network connection, wherein each of the plurality of computing systems may implement part of the loyalty platform 108. Loyalty platform 108 may be configured to electronically communicate with external computing systems, such as user computing systems 102, 116, and 118, businesses 106, 138, and 140, clearing system 104, and payments system 150. In one example, loyalty platform 108, may be configured to electronically communicate with one or more additional computing systems, via a network, such as the Internet, wherein the electronic communication may in one example comprise transmission and reception of data between the loyalty platform 108 an one or more additional computing systems.

User computing devices 102, 116, and 118, which may interface with loyalty platform 108 via a network connection, may each be associated with at least one user, and further associated with at least one user account stored in non-transitory memory of one or more a computing systems implementing loyalty platform 108. As an example, use of the term “user” or “prospective user” or may refer to any legal entity, whether individual or corporate. Each user computing device may be associated with a user, and thus enable the user to communicate with loyalty platform 108. In one example, user computing devices 102, 116, and 118, may be associated with user accounts 172, 174, and 176 and may be any associated corporation or associated individual. Users associated with user computing devices 102, 116, and 118 may register with loyalty platform 108 and make user purchases at a plurality of businesses, such as businesses 138, 140, and 106. Based upon user loyalty selections, wherein a loyalty selection may comprise a selection of an exclusionary loyalty to one business in a market, the user may be entitled to a fractional equity reward upon executing a user loyalty purchase (a purchase between a user and a business with which the user has made a loyalty selection). Additionally, the user may be excluded from receiving rewards from unselected businesses based on the loyalty selection. In one example, upon distribution of the fractional equity reward to a user account, such as user account 172 within user accounts 114 on loyalty platform 108, the loyalty platform 108 may transmit an equity reward status via network connection to the user computing device to display information pertaining to a pending fractional equity reward (as used herein, the terms pending fractional equity reward, and pending reward, refer to a fractional share of stock to which a user is entitled based on a user loyalty purchase, but which has not yet been distributed to the user). In one example, an equity reward status may indicate a current stage or state of reward distribution for a pending fractional equity reward, or for a plurality of pending fractional equity rewards. In another example, an equity reward status may include an estimated fulfillment time for a pending fractional equity reward, such as an expected date by which the pending fractional equity reward may be distributed to the user account, or an estimated duration of time until one or more stages or steps of the reward distribution process are completed (for example, a stage or step of the reward distribution process may comprise one or more of calculating the fractional equity reward, aggregating the fractional equity reward, purchasing the fractional equity reward, and distributing the fractional equity reward to the user account).

User computing devices 102, 116, and 118, may each include a processor, memory, communication interface, display, user input devices, Global Positioning System (GPS)/position sensors and/or other components. In one example, a location (e.g., a geolocation) of user computing device 116 may be determined via a GPS system associated therewith. In one example, information from loyalty platform 108 may be transmitted to user computing device 118 via a network connection (such as the Internet) between user computing device 118 and loyalty platform 108, for rendering within an interface or display implemented at user computing device 116. The display may be used to present a visual representation of the loyalty platform 108. This visual representation may take the form of a graphical user interface (GUI), examples of which are illustrated in FIGS. 5A and 5B. The communication interface may communicatively couple the loyalty platform 108 with one or more other computing systems, such as the payments system 150, clearing system 104, user computing devices, and/or one or more business computing devices. The communication interface may include wired and/or wireless communication devices compatible with one or more different communication protocols. As non-limiting examples, the communication interface may be configured for communication via a wireless telephone network, or a wired or wireless local- or wide-area network. User input device(s) may comprise one or more user-input devices such as a keyboard, mouse, touch screen, or game controller.

Clearing system 104 may comprise one or more computing devices each including a processor, memory, communication interface, and/or other components. The memory of the computing device(s) of clearing system 104 includes instructions or rules for managing a clearing house for assignment of public shares. As a further example, clearing system 104 may comprise a clearing house for assignment of non-public shares. Clearing system 104 may communicate with equity allocation system 120 of loyalty platform 108 in order to execute transactions such as the buying or selling of shares, or fractional shares, via an average price account of the equity allocation system 120.

Payments system 150 may comprise one or more computing devices each including a processor, memory, communication interface, network adapter, user input device(s), and/or other components. The memory of the computing device(s) of payments system 150 includes instructions or rules for disbursing and/or receiving payments via one or more banks, bank accounts, credit card accounts, checking accounts, online payments systems, or virtual wallets. In some examples, payments system 150 may include discrete accounts, each of which may be associated with a user account 172, 174, and/or 176 of accounts 114 on the loyalty platform 108.

Businesses 138, 140, and 106 may be any merchant, business place, brand, bank, financial institution, entrepreneur or entrepreneurial entity associated with loyalty platform 108. As an example, use of the term “business” or “merchant” or “brand” may contemplate any stock corporation, whether private or public. Each business may communicate with loyalty platform 108, for example, via a business computing device. Each user computing device may include a processor, memory storing instructions executable by the processor, display, user input devices, and a communication interface.

Any of the computing devices, modules, or elements described herein with reference to FIG. 1A and FIG. 1B may communicate with each other via a network. For example, loyalty platform 108 may communicate with clearing system 104 and payments system 150 via a network.

Loyalty platform 108 may include a plurality of modules including a loyalty manager 110, rewards manager 112, accounts 114, equity allocation system 120, purchase tracking 122, platform account 136, dividend distribution 152, and reward modifier 154. As illustrated in exemplary FIG. 1B, the various modules of the loyalty platform 108 may include instructions stored in non-transitory memory 184 that are executable by processor 182 of computing system 180. In other examples, the modules may be stored on multiple memories and/or executed by multiple processors distributed across multiple computing devices connected by a network.

Loyalty manager 110 administers loyalty policies 142 and updates user loyalties 126 of accounts 114 with updated loyalty policies relating to businesses to which a user may make a loyalty selection. Loyalty manager 110 includes loyalty policies 142 and markets 156. Markets 156 may be a database or module which may further represent suitable information regarding categorization of businesses affiliated with loyalty platform 108 into discrete markets or business segments wherein the businesses segmented into different markets compete in some way or offer similar products and/or services, additionally/alternatively, such information may be stored in rewarding business index 186 shown in FIG. 1B. Loyalty manager 110 may represent suitable information regarding loyalty selections of the loyalty platform 108. As a non-limiting example, loyalty manager 110 may include market definitions for a market such as “Groceries (National).” In some examples, businesses not affiliated and/or businesses pending affiliation or partnership with the platform may be listed in the markets database. In an example, businesses listed in the markets database may have different statuses such as “non-partner” (if not partnered with the platform), “partner” (if partnered with the platform), and “pending partner” (if partnership with the platform is pending). Business statuses in the markets 156 may be useful as they may allow users to be made aware of businesses which may or may not become platform partners over time, which may factor into a user's decision to make a loyalty selection to a particular business in a market. In one example, a “Groceries (National)” market might include large, nation-wide grocery chains, not limited to, for example, COSTCO, ALBERTSON'S, DOLLAR GENERAL, KROGER. In an example, a market may include any number of businesses, and there may be any number of markets included in markets 156. In an example, market definitions may be defined by administrators of the platform account 136.

Additionally, loyalty manager 110 may include loyalty policies 142 which may further include instructions or information relating to managing loyalties across markets 156 of loyalty platform 108. Separating businesses into individual markets is not so simple, as many business and/or merchants exist not only in one market, but are diversified and compete in many different markets. For example, a massive big-box store, such as WALMART sells not only groceries, but also home goods such as electronics, prescription medications, and clothing. As such, loyalty manager 110 may further include loyalty policies 142 that limit the loyalty selections for a user across different markets, so that a user may only select loyalty to a particular business across different markets (of markets 156) a particular number of times. In an example, a user may be allowed to select loyalty to only one business for a single market. In another example, a user may be allowed to select a first loyalty to a business in a first market and to select a second loyalty to the business in a second market. In a further example, a user may be allowed to select loyalty to a business as many times as allowed by loyalty policies 142 across different markets, if the business is “multi-listed” or offered as a loyalty selection across different markets. In a further example, a user may be allowed to select loyalty to one or more businesses listed within a market.

Rewards manager 112 may be a module or database and may include reward policies 144 which may further include instructions or information comprising rules for providing fractional equity rewards based upon a user's selected loyalty to a transacting business (business with which transaction occurs). Additionally, reward policies 144, in an example, may include specific rule sets regarding equity rewards for a user executing purchases at or with a particular business (herein referred to as business reward policies) to which the user has selected loyalty via the loyalty platform. As an example, a user's long-term loyalty may be rewarded with increased equity rewards. In some examples, equity rewards may increase over time. In some examples, equity rewards may randomly and/or predictably vary over time. In some examples, variable, increasing, and/or long-term loyalty rewards may form stronger user-business relationships and user loyalty. Additionally, if a user switches loyalties from a first company in a first market to a second company in the first market, a promotional, “loyalty-switch offer” may be made available to the user. In an example, a “loyalty-switch offer” may comprise a period of increased equity rewards per transaction with the business. In an example, a “loyalty-switch offer” might also comprise any of a cash reward, discounted purchases, a set amount of equity, or any other loyalty-switch promotion desired by the administrators of the loyalty platform. As a further example, administrator account 158 or platform account 136 may modify reward policies 144 of rewards manager 112.

Accounts 114 may be a module or database including instructions, information, and/or rules relating to personal and loyalty platform information for each user 102, 116, and 118 associated with the loyalty platform 108. As an example, users 102, 116, and 118 may register with loyalty platform 108 via a smartphone, computer, point-of-sale unit at businesses 106, 138, 140, or other network-enabled computing device in order to build and create user accounts 172, 174, 176 associated with (as an example) users 102, 116, and 118, respectively, the accounts being stored in accounts 114. As an example, accounts 114 may include user information for each user, including user loyalties 126, user rewards 128, equity assigned to user 130, user transactions 132, user payments 134 (including, in some examples, payment preferences, methods, or payment media), and user funds 160. As an example, user loyalties 126 may include the businesses and/or brands to which the user has made a loyalty selection in a defined market, and which may be displayed to a user via a graphical user interface. User rewards 128 of a user's account may include the rewards for which the user is currently eligible based on user loyalty purchases, such as when making a transaction using payment media registered (or linked) with purchase tracking 122. As used herein, payment media, or a payment medium, may refer to credit cards, debit cards, virtual wallets, or other devices capable of conducting electronic transactions, which are associated with a payment account, such as a checking account. User equity 130 may include equity currently assigned to a user, such as fractional shares of stock. User transactions 132 may include a history of tracked user purchases executed by a user using one or more linked payment media and tracked by loyalty platform 108 via purchase tracking 122. User payment 134 may include user preferences for payment or a virtual wallet held by the loyalty platform 108. User funds 160 may include electronic funds stored for a user which may be used for purchases made via the platform or, as an example, user funds 160 may include funds received via dividend payments from dividend distribution 152. As an example, accounts 114 may be updated continuously, via communication between rewards manager 112, loyalty manager 110, purchase tracking 122, equity allocation system 120, dividend distribution 152 and reward modifier 154, on a schedule, or in response to a trigger in order to keep user account information updated so that a user may be able to receive up-to-date information regarding their account. In an example, purchase tracking 122 may trigger a user account 172 update based upon receiving a notification of a tracked user loyalty purchase, and purchase tracking may command rewards manager 112 and loyalty manager 110 to update the user account 172, such as by transmitting an equity reward status to user account 172 based on the tracked user loyalty purchase.

Equity allocation system 120 may manage purchasing, distributing, selling/liquidating, and forfeiting equity as well as updating current share prices. Equity allocation system 120 may include forfeit module 146, updater module 147, assign module 148, and sell module 178, and may be a module or database configured with rules and/or instructions for executing buy, sell, and/or forfeit orders of fractional or whole shares between loyalty platform 108 and clearing system 104 as well as, in some examples, between accounts 114 (including user accounts 172, 174, 176) and platform account 136. Equity allocation system 120 may additionally comprise a plurality of merchant deposit accounts for holding funds used to purchasing equity rewards, an inventory account for holding fractional remainders of shares leftover after distribution of fractional equity rewards to the plurality of users is complete, an average price account for conducting street-side whole share purchases and sells, as well as one or more merchant facilitation accounts for temporarily holding fractional equity rewards during fractional equity reward distribution.

Purchase tracking 122 may be a database or module configured to include instructions and rules configured to track virtual and real-world (e.g., in-store) purchases between users 102, 116, 118 and businesses 138, 140, 106. The purchase tracking system may further include payment medium storage database 124 in order to track purchases for user accounts 172, 174, 176 associated with user computing devices 102, 116, 118 who may execute transactions using payment media which have been registered (linked) and stored at payment medium storage 124. As an example, payment media stored within payment media storage 124 may include any applicable payment methods not limited to credit cards, debit cards, and online payment systems (for example, PAYPAL). In an example, payment medium storage 124 may include registration information relating to credit cards used for transactions between users and businesses. In another example, payment medium storage 124 may include registration information relating to only payments systems used for transaction between users and businesses. In another example, purchase tracking 122 may receive a notification or indication that a user has executed a transaction (for example, purchase or return).

The loyalty platform 108 may include platform account 136, which may comprise an administrator account 158 enabling platform administrators with the ability to make modifications to the loyalty platform 108, for example, adding or removing businesses to the loyalty selections available through loyalty manager 110, modifying rewards options available through rewards manager 112, modifying accounts 114, modifying equity allocation system 120, modifying dividend distribution 152, and varying the rewards provided to users at reward modifier 154.

Loyalty platform 108 may also include dividend distribution 152 as a database or module comprising instructions or rules which may enable communication with clearing system 104 in order to distribute dividend payments whenever they are set to occur (such as quarterly). Clearing system 104 may, as an example, have information relating to when dividend payments are to be made and how much money or stock per share may paid-out. In one example, if a first business initiates a dividend payment process while a user holds a number of shares of stock in that business, but the user sells the number of shares of stock in the business before the dividend is received by the loyalty platform (such as may occur upon a user selecting to switch loyalty from the first business to a second business), once the dividend is received by the loyalty platform the loyalty platform may offer that dividend to the user as a cash reward (if the dividend comprises cash) or as an equity reward (if the dividend comprises an amount of shares of stock), the loyalty platform may further offer the user an option to redistribute the received dividend using one or more of the methods herein disclosed, such as method 400. Dividend payments handled by dividend distribution 152 may, in some examples, be sent to user funds 160 in user account 172. In another example, dividend payments handled by dividend distribution 152 may be sent directly to payments 150 via instructions included at user funds 160 to send payment to an account with payments 150 associated with user account 172.

Reward modifier 154 may be a module or database containing instructions configured to provide a reward modification to the normal reward, based upon random selection or based upon one or more actions taken by the user, such as a loyalty switch, accumulating more than a threshold amount of loyalty rewards, or further based one or more policies or promotional events of the rewarding business. As an example, the user may be entitled to a reward, or a normal reward, based upon the user's loyalty selection to a business, and, the normal reward may be modified based upon variable reward policies (discussed herein) to form a modified reward. As explained herein, when a user 102, 116, 118 executes a transaction, the purchase tracking 122 notifies reward modifier 154 of the transaction (which may have been made between a user and business wherein the user had made a loyalty selection to the business of the transaction) and further queries reward modifier 154 to see if the normal reward may receive a modified reward.

Turning now to FIG. 1B, example computing system 180 is shown. Computing system 180 may implement loyalty platform 108 alone, or in combination with other computing systems. In one example, computing system 180 may comprise a server. Computing system 180 includes display 175, input device 173, processor 182, network adapter 188, and non-transitory memory 184. Display 175 may comprise a monitor, touch screen, projector, or any other device known in the art of computers for enabling a user to observe or sense information rendered by a digital device. Computing system 180 may have stored within non-transitory memory 184 instructions for rendering data, such as loyalty platform 108 data, within a graphical user interface which may be displayed by display 175. Input device 173 enables a user to interface/interact with computing system 170, and may comprise one or more hardware devices, such as a mouse, keyboard, touch screen, motion tracking camera, or other devices configured to transform user motions, gestures, sounds, or other user actions into an electronic form which may enable a user to input data, or transmit, select, modify, or otherwise interact with data or data structures stored in or displayed by computing system 180. Processor 182 may include one or more physical devices configured to execute instructions stored in non-transitory memory. For example, processor 182 may be configured to execute instructions that are part of one or more applications, services, programs, routines, libraries, objects, components, data structures, or other logical constructs included in loyalty platform 108. Network adapter 188 may comprises one or more physical device associated with computing system 180, enabling transmission and reception of data between computing system 180 and one or more additional computing systems. Network adapter 188 may enable computing system 180 to access a local area network, and/or the Internet, and exchange data therewith, such as data which may enable tracking of user purchases and matching between transacting businesses and businesses registered with the loyalty platform (and therefor included in the rewarding-business index). Non-transitory 184 memory includes one or more physical devices configured to hold data, including instructions executable by the processor to implement the methods and processes described herein. When such methods and processes are implemented, the state of non-transitory memory 184 may be transformed—e.g., to hold different data. The terms “module” and “program” may be used to describe an aspect of the computing system implemented to perform a particular function. The terms “module” and “program” may encompass individual or groups of executable files, data files, libraries, drivers, scripts, database records, etc. Non-transitory memory 184 includes the various files/routines/methods of loyalty platform 108 that when executed by processor 182 perform one or more of the steps herein described with reference to one or more of the disclosed methods. Computing system 180 may optionally include display(s), user input device(s), communication interface(s), and/or other components.

As shown in FIG. 1B, non-transitory memory 184 includes rewarding-business index 186. Rewarding-business index 186 may be stored within non-transitory memory 184 of computing system 180, and may comprise a database or module containing information regarding businesses registered with loyalty platform 108. In one example, rewarding-business index 186 may be used by computing system 180 in conjunction with purchase tracking 122 to quickly determine if a user purchase executed at a business is eligible for a fractional equity reward by matching a description of the transacting business, obtained by purchase tracking 122, with a description stored in rewarding-business index 186 associated with a business offering fractional equity rewards to loyalty users through loyalty platform 108. In some examples, computing system 180 may be configured to implement a neural network, wherein the neural network comprises a classifier type neural network, configured to receive as input one or more details of a user transaction/purchase (also referred to as a transacting business description) and to use said input to produce as output a probability rank for one or more, or each, of the businesses stored within rewarding business index 186, wherein the probability rank indicates for a given business, the probability that the purchase occurred with said business. In other examples, computing system 180 may be configured to execute one or more machine learning algorithms capable of learning a non-linear mapping from a feature space comprising purchase details, to an output space comprising business classification scores/probabilities, wherein the learning algorithms may have access to rewarding business index 186, which includes an up to date listing of all businesses partnered with the loyalty platform.

To facilitate accurate matching between a transacting business and its associated reward program/policies implemented by loyalty platform 108, rewarding-business index 186 may include various features, or pieces of data, relating to the businesses listed therein. In one example, rewarding-business index 186 comprises a database, with each entry therein corresponding to a unique business, said entry may comprise a name/title, a link to the reward/loyalty policies established by the business, the status of the reward program associated with that business (such as “active”, “cancelled”, “pending deposit of funds”, etc.). In one example, a business interested in offering equity rewards via loyalty platform 108 to customers, to incentivize greater customer loyalty, may register their business with loyalty platform 108. The registration process for businesses may include inputting information relating to the business into loyalty platform 108, this information may be stored in non-transitory memory of computing systems implementing loyalty platform 108. In one example, business information may be stored in rewarding-business index 186 of one or more computing systems implementing the loyalty platform 108, such as computing system 180. As an example, the business information input into the rewarding-business index as part of the business registration process may include a description of the business, business payment information, business contact information, business locations/addresses, business hours of operation, markets in which the business operates (which may also be stored in markets 156), business reward policies/loyalty policies defining how a fractional equity reward is determined based on tracked user loyalty purchases (which may also be stored in one or more additional locations of loyalty platform 108, such as in loyalty policies 142, and reward policies 144), and other information which may enable the loyalty platform 108 to uniquely identify the business and operate a customer loyalty program customized for that individual business. In one example, a link to loyalty policies and/or reward policies associated with a business registered with the loyalty platform 108 may be included in an entry in rewarding-business index 186. In one example, rewarding business index 186 may contain an equation or algorithm (or a link pointing to a location in non-transitory memory wherein the equation or algorithm is stored) for determining an amount of fractional shares of stock to be allotted to a user based on a tracked user loyalty purchase conducted using a linked payment medium. A business listed in rewarding-business index 186 may be removed, deleted, or overwritten, upon suspension or cancellation of the equity rewards program established for that business. In another example, upon cancellation or suspension of a customer loyalty program offered by a business, a flag may be set in the entry corresponding to that business in the rewarding-business index, thereby indicating that no equity rewards may be earned based on tracked user loyalty purchases at this business at this time, thus retaining business information within the rewarding-business index and bypassing the need to re-enter information relating to said business into the rewarding-business index in the event that the customer loyalty program associated with the business is resumed at a later time. Rewarding-business index 186 may be stored in a location of non-transitory memory 184 of computing system 180, and information stored therein may be accessed by computing system 180 upon execution by processor 182 of one or more methods stored in loyalty platform 108, some examples of which are described herein. In one example, rewarding-business index 186 may be accessed by purchase tracking 122 of loyalty platform 108 to attempt to match/correlate a description of a business with which a user recently made a purchase (herein also referred to as a transacting business description) with a description stored in rewarding-business index 186. The transacting business description, comprising data pertaining to the transacting business, may be obtained by loyalty platform 108 via a linked payment medium used to conduct the purchase, or alternatively, through a point of sale device of the transacting business which is configured to transmit purchase details to the loyalty platform, or from a third party purchase data aggregator such as Plaid. If the transacting business description matches a description of a business stored in rewarding-business index 186, the user may be entitled to a fractional equity reward for the tracked user loyalty purchase, and one or more additional actions may be taken, such as look-up of the reward policies linked with the rewarding business. The link may be stored in rewarding business-index 186 in a location associated with the rewarding business description, the link may point to a location of non-transitory memory 184 associated with reward policies 144. Thus, rewarding-business index 186 enables computing system 180 to automatically determine if a tracked user purchase is eligible to receive a reward, or may be eligible to receive a reward (such as upon a user accepting a loyalty-switch offer), without requiring the user to submit proof-of-purchase information, or perform other potentially annoying tasks employed by conventional rewards programs.

In this way, rewarding-business index 186 may enable loyalty platform 108 to rapidly and automatically determine if a tracked user purchase is in fact a tracked user loyalty purchase, and is therefore eligible to receive a fractional equity reward. This may reduce the time between when a user executes a user loyalty purchase, and when a fractional equity reward based on that purchase is distributed to the user compared to conventional approaches which require a user to manually input a code, or other proof-of-purchase/proof-of-reward.

The following methods give examples of one or more methods which may be executed by a computing system, such as computing system 180, to implement a loyalty platform, such as loyalty platform 108, which may enable one or more improvements over conventional reward programs.

Turning now to FIGS. 2A, 2B, and 2C, a flowchart illustrating exemplary method 200 is shown. Method 200 is an example of a process illustrating how an online loyalty platform, such as loyalty platform 108, may track user purchases conducted with a payment medium registered/linked to a user account of the loyalty platform, and allocate equity rewards based on the monetary value of the user purchase, a user transaction history, user loyalty selections, business rewards policies/loyalty policies. In this and other examples, “loyalty” or “loyalty selection” may be a selection of a first business in a market made by a user entitling the user to certain privileges including, but not limited to, equity rewards, discounts, special offers, promotions, and others. Making a “loyalty” selection entitles the user to the receipt of privileges from the first business of the market to which the user has made their “loyalty selection” with, but may preclude, or exclude, the user from receiving privileges from a second business, or other businesses, in the market. In some examples, a user may be presented with a “loyalty-switch offer” which may be an offer for other privileges provided by a second business in the market, based upon a forfeit of loyalty and privileges to the first business and a selection of loyalty to the second business in the market.

Beginning with 202, purchase tracking 122 of loyalty platform may receive an indication, or notification, that a user (for example, user 102, 116, 118 of FIG. 1A) has made a purchase or executed a transaction, comprising a monetary value of the transaction, with a transacting business. Purchase tracking 122 may further receive one or more purchase details, including information regarding the transacting business (herein referred to as a transacting business description), and to which customer account the transaction medium is associated. In one example, the transacting business description may include a title/name of the transacting business, the address of the transacting business, a time and date of the transaction, information relating to a point of sale device used to conduct the transaction, or other data associated with conduction of the user purchase which may be used to uniquely identify a transacting business. Purchase details may further comprise information identifying which user account on the loyalty platform to associate with the user purchase. As described further, herein, purchase tracking 122 may be configured to link to credit cards, debit cards, or any other trackable payment medium, and when the link is completed, the purchase tracking 122 may receive all purchase notifications made with that trackable payment medium. As an example relating to FIG. 2A, a user may make a purchase with the use of a credit card, tracked by purchase tracking 122, at a business. Additionally, a spend history/transaction history associated with each payment medium, and/or associated with each user account (in the case that a user account is associated with multiple linked payment media), may be generated for linked payment media and stored in non-transitory memory of the rewards platform. In one example, the reward policies of a business stored on the loyalty platform may take into account the transaction history of a user when determining the amount of the equity reward to allocate to the user. In one example, determining the amount of the equity reward to allocate to the user comprises increasing a percentage of a monetary value of a user purchase used to reward the user based on a cumulative monetary value of user purchases from the rewarding business increasing beyond a threshold, wherein the threshold may be defined in the reward policies of the business and the cumulative monetary value of user purchases may be calculated on a rolling basis over a predetermined duration of time. In another example, based upon a cumulative transaction amount for a user with a single rewarding business within a finite duration of time increasing beyond a predetermined threshold amount, the amount of the equity reward allocated to a user as a fraction of the total transaction amount may increase. As an example, the transacting business may be listed within markets 156.

At 204 the loyalty platform may employ a purchase tracking system or module to identify the business and the user involved in a user purchase. The payment medium used in the user purchase may be uniquely associated with an account of a user on the loyalty platform, such as one of accounts 114 stored in the non-transitory memory 184 of computing system 180. In another example, the business with which the user conducted the transaction may be identified by the computing system implementing the loyalty platform by matching/correlating a transacting business description associated with the user purchase with a description of a business stored in the rewarding-business index of the loyalty platform. In one example, a match between a transacting business description and a description of a business stored in a rewarding-business index of the non-transitory memory of the computing system implies that the transacting business is registered with the loyalty platform, and therefore, that the user may be eligible for an equity reward based on the user purchase (note that in some examples the rewarding-business index may include an indication that the reward program of the registered business is cancelled or suspended, such as may be indicated by a flag included with the listing of the business in the rewarding-business index as previously discussed). In another example, if the computing system implementing the loyalty platform is unable to match the transacting business description with a description for a business stored in the rewarding-business index, this implies that the transacting business is not registered with the loyalty platform, and thus the user may be ineligible to receive an equity reward for the user purchase. In this way, for a user purchase identified by a purchase tracking system or module of a loyalty platform, such as purchase tracking 122, both the user and the transacting business may be rapidly identified using the system and methods of the current application, so long as the transacting business is registered with the loyalty platform. Further, it may be quickly ascertained if the tracked user purchase is eligible for an equity reward. And in some examples, in the event that the user purchase is not eligible for an equity reward, the computing system implementing the loyalty platform may transmit a notification to a user computing device, for rendering on a display or communications interface of the user computing device, a notification to the user that their purchase was not eligible for a reward, the notification may further include an offer to the user to make a loyalty selection to one or more businesses stored a rewarding-business index of the non-transitory memory of the computing system which are actively offering equity rewards to loyalty selecting users.

Moving to 206, the computing system implementing the loyalty platform may then execute a user loyalty lookup, comprising looking up the user's active loyalties stored in the account associated with the user. In one example the user loyalties, such as may be stored at user loyalties 126 of loyalty platform 108, may comprise recorded loyalty selections made by a user associated with an account stored within accounts 114, said account further associated with the linked payment medium used to conduct the purchase. In another example, a computing system implementing the loyalty platform may receive a loyalty selection from a user computing device, the loyalty selection comprising a user selection of a business listed in a rewarding-business index stored on the non-transitory memory of the computing system, the business listed in a market, and based upon the user selection of the business, the user is eligible to receive an equity reward associated with the business and is excluded from receiving equity rewards associated with unselected businesses in the market. The computing system may then conduct the process of storing the loyalty selection in a location of the non-transitory memory of the computing device associated with an account of the user, which may subsequently be accessed in order to determine if a user is loyal to a transacting business. In one example, loyalty selections may only be made to companies providing equity rewards to users through the loyalty platform, and thus listed in the rewarding-business index, as loyalty selections to other businesses would not enable the user to receive an equity reward, and thus the user would obtain no benefit from such a loyalty selection.

Proceeding to 208, the method includes determining if the user is loyal to any business in the market. If the user loyalty lookup returns that the user is loyal to a business or merchant or brand in the market, then the method proceeds to 201 of FIG. 2B, which will be explained in more detail below. As a further example, the user loyalty lookup may be executed by the purchase tracking 122.

If the user loyalty lookup determines the user is not loyal to any business in the market, the method proceeds to 210, where the purchase tracking 122 requests, or queries, loyalty manager 110 for available or offered user equity rewards with the transacting business. Additionally, at 210, the loyalty manager 110 may provide an option for the user to select loyalty in the market to the transacting business. The option provided by loyalty manager 110 may include information regarding loyalty policies 142 relating to the transacting business. The option provided by loyalty manager 110 may, in an example, include notifications of the rewards available to the user if the user should select the option for the user to select loyalty in the market to the transacting business.

Proceeding to 212, method 200 determines if the user has switched loyalty to the transacting business. If the user does select the loyalty-switch offer, the method may proceed to 216, wherein the user may earn the loyalty-switch offer. Additionally, as an example, the loyalty manager 110 module may update the user's loyalties at user loyalties 126 of accounts 114, by overwriting the previous loyalty selection of the user in that market, and the rewards manager 112 may update the user's current rewards at user rewards 128 of accounts 114. Furthermore, if the user accepts the loyalty-switch offer, the method may proceed to 203 of FIG. 2C. If the user does not select the loyalty-switch offer, the method may proceed to 214 wherein the user earns no equity rewards, privileges, or any other rewards which may comprise selecting the loyalty-switch offer and selecting loyalty to the transacting business. Additional operations that may occur responsive to a user request to switch loyalties is described below with respect to FIG. 4.

Continuing now with FIG. 2B, at 218 method 200 includes determining if the user has made a loyalty selection to the transacting business. Determining if the user made a loyalty selection to the transacting business may include looking up the user's loyalties stored in accounts 114 at user loyalties 126 via purchasing module 122 executing the user loyalty lookup. If the user loyalty lookup returns that the user is loyal to the transacting business, and should therefore receive a reward according to the loyalty policies set forth, the method may proceed to 203 of FIG. 2C, explained in more detail below. If the lookup at step 218 determines that the user is not loyal to the transacting business, method 200 may then proceed to 220 where the loyalty manager 110 may present the user with a loyalty-switch offer which may include an option for the user to select a loyalty to the transacting business and terminate their previously-selected loyalty to another business in the market. As an example, the terms and policies of a loyalty-switch offer may be stored within loyalty policies 142. In some examples, loyalty-switch offers may include whole or fractional shares of stock. In some examples, loyalty-switch offers may include equity rewards offered on transactions and/or discounts on transactions. In an example, loyalty-switch offers may be temporary or permanent or may be based upon any user behavior as defined by the business responsible for the loyalty-switch offer and/or the platform. In an example, loyalty-switch offers may include temporarily higher or increased equity rewards for transactions executed with the transacting business.

Additionally, loyalty-switch offers may be presented, offered, or made available to the user at any time, for example, when the user is browsing through available loyalty selections, or as another example, at any desirable time when a user is interacting with the platform. In an example, a user who is conducting a transaction with a business, with which the user has not selected loyalty in a market, may receive a notification, for example via the purchase tracking 122 or loyalty manager 110. The purchase tracking or loyalty manager may inform the user that they are not receiving equity rewards at the business where they are conducting the transaction. In some cases if the user is merely present within, at, or near a business listed in the rewarding-business index to which the user does not have an active loyalty selection, the notification may further include a loyalty-switch offer so that the user may begin to earn rewards and/or privileges associated with the business. In one example, the user computing device may contain GPS capabilities, the computing system implementing the loyalty platform configured to receive the location of the device therefrom, and to correlate the location of the user computing device with predefined location information specified for one or more of the plurality of businesses in the rewarding-business index. Thus, the computing system implementing the loyalty platform may be enabled to ascertain when the user computing device is within a threshold distance of one or more businesses registered with the loyalty platform, and therefore listed in the rewarding-business index. In one example, based on the user computing device being less than a threshold distance from one of the plurality of businesses listed in the rewarding-business index, an offer for a loyalty selection to the said one or more businesses may be transmitted to the user computing device, for display via a display or communications interface of the user computing device. In a further example, based on a location of the user computing device, and a local time of the location of the user computing device, and the spend history of one or more payment media associated with the user, a customized loyalty-switch offer may be transmitted to the computing device of the user. In another example, the threshold distance may be a predetermined distance, such as 1 mile. In other examples, the threshold distance may be based on a rate of user travel, or an estimated travel path of the user as indicated by a derivative of the position signal being transmitted to the loyalty platform.

In another example, a user may elect to switch-loyalties after receiving a loyalty-review from the loyalty platform. In one example, a “loyalty review” may display to a user a purchase history, along with an indication of which purchases received loyalty rewards, which purchases did not receive loyalty rewards, and which purchases could have received a greater amount of loyalty rewards if a loyalty-switch was made. For example, the loyalty platform may display a “loyalty review” button within a user interface on a display of a user device, upon selection of the “loyalty review” button by the consumer, a purchase history in the grocery category (as used herein, a category of the loyalty platform is equivalent to a market of the loyalty platform) may be displayed in the user interface, wherein the purchase history may indicate that the user was spending 40% (of the total spent in the grocery category of the loyalty platform) over the last 3 months at Kroger, and 60% at Albertson's, but their loyalty is to Kroger. Based on the information displayed to the user by the loyalty review, the user may elect to switch loyalties from Kroger to Albertson's. In one example, the loyalty review may include automatically prompting a user with a loyalty-switch offer upon a determination that the user spends more with a business in a market to which the user is not currently loyal than the user spends with a business to which the user is currently loyal.

After presenting the loyalty-switch offer to the customer, at 222, the method 200 continues where the purchase tracking 122 queries loyalty manager 110 and/or user loyalties 126 to determine if the user has switched loyalty to the transacting business. If the user does not switch loyalty to the transacting business and declines the loyalty-switch offer, the method 200 may proceed to 226 where the user earns no equity rewards for the transaction. Contrastingly, if the user does switch loyalty to the transacting business, the method 200 may proceed to 224 where the loyalty manager 110 may update the user's loyalties at user loyalties 126 of accounts 114. The method may further include the rewards manager 112 updating the user's rewards 128 of user account 172 to include the privileges and/or benefits of the loyalty-switch offer. After the user account (for example, user account 172) has been updated, the method 200 may then proceed to 203 of FIG. 2C. As an example, if a user has selected loyalty to a first business but then selects loyalty to a second business in a same market via a loyalty-switch offer, the purchase tracking may update user loyalties 126 to include information that the user has now canceled loyalty or loyalty selection to the first business and selected loyalty to the second business.

Turning now to FIG. 2C, the reward modifier 154 may also provide modified rewards to the user based upon random selection, user action, or rewarding business policy/promotional event. At 228 of method 200, the purchase tracking 122 may have tracked a purchase between a user and a business with which the user has made a loyalty selection. The purchase tracking 122 may communicate with the reward modifier 154 per each transaction tracked by loyalty platform 108. In one example, the reward modifier 154 may include a random selection algorithm 162, which may be invoked to randomly provide modified rewards to the user. As an example, the random selection algorithm 162 may be implemented within the reward modifier 154 and the reward modifier 154 may further include variable reward policies 164 which include rules and/or instructions for how to provide variable rewards. In addition, reward modifier 154 may include promotional engine 166, which may comprise rules/instructions for modifying a user reward based upon previous user actions, such as a loyalty switch, a loyalty streak (a period of time of continuous loyalty to a brand), in conjunction with reward policies of a rewarding business. In one example, rewarding business Z may provide a 40% reward increase to users who switched loyalty from another business operating in a same market as business Z, and promotional engine 166 may include instructions for determining if a user has executed such a loyalty switch, and may further include instructions for modifying a base reward by increasing the amount of the base reward by 40%. In another example, rewarding business Z may conduct a promotional event, wherein all purchases made by loyalty users receive a first reward amount, and wherein higher reward amounts may be given to users based on the user meeting one or more pre-determined criteria, such as the user having been loyal to business Z for greater than a threshold duration. Promotional engine 166 may therefore comprise instructions which when executed enable query and comparison of one or more pieces of user data, such as may be obtained from user accounts 114, which may enable determination by reward modifier 154 if a user is eligible to receive a modified award. In one example, promotional engine 166 may work in concert with random selection algorithm 162. In one example, promotional engine 166 may be configured with instructions to reward 60% of user's loyal to brand Z with an increased reward based upon tracked purchases, and promotional engine 166 may invoke random selection algorithm 162 to randomly select 60% of tracked loyalty purchases made with brand Z and provide the randomly selected 60% of purchases with the increased reward.

At 230, the reward modifier 154, as an example, may invoke the random selection algorithm 162 to determine if a tracked transaction (made between a user and a transacting business wherein the user has selected loyalty to the transacting business) may or may not receive a modified reward, and the reward modifier 154 may also modify the reward based upon variable reward policies 164.

At 232, if the tracked transaction is determined to receive a modified or variable reward, the method may proceed to 244 wherein, the variable reward modifier may apply variable reward policies 164 to the normal reward. At 244, the variable reward modifier may run a user loyalty lookup to determine the reward, or normal reward, associated with selected loyalty to the business based upon reward policies 144. At 232, if the tracked transaction is not determined to receive a modified or variable reward, the method may proceed to 234. Similarly, at 234 the variable reward modifier may run a user loyalty lookup to determine the reward, or normal reward, associated with selected loyalty to the business based upon reward policies 144.

The variable reward policies 164 may contain instructions and/or rule sets related to the modifications of the normal reward of any tracked transaction based upon the results of the random selection algorithm 162 having determined the tracked transaction may receive a modified reward. In an example, a variable reward policy may include a modification policy which may invoke the random selection algorithm 162 yet again to determine, by random selection, a degree of modification from a list of possible modifications. In an example, the variable reward policy may include the modification policy comprising a list of possible modifications comprising reward multipliers, for example, 2×, 3×, and 4×. By invoking the random selection algorithm 162 to choose, by random selection, from the list of possible reward modifications (for example, multipliers 2×, 3×, and 4×), the variable reward policy may randomly select a reward modification, and in such an example, if a 3× reward multiplier were chosen, then the reward amount, (for example, equity reward) which may be given to the user as a discount charged to the merchant, may be multiplied by 3. In an example, a user may execute a $100 tracked transaction with a business the user has selected loyalty to. With no reward modification, the user may normally receive a 1% discount via the loyalty platform 108. However, if the user may be determined to receive a variable reward including, for example, a 3× reward multiplier (in accordance with the variable reward policies 164), then the user would receive a 3% discount which would then be charged to the transacting business (along with the service charge, which may or may not also be modified by the reward modification). Furthermore, the user may be assigned $3 worth of fractional or whole shares of equity in the transacting business via the equity allocation system 120.

If, the variable reward modifier 154 applies reward modification policies to the normal reward at 244, next, the method 200 may then proceed to 246 and the variable reward modifier 154 may provide the modified and/or variable reward (the normal reward of 128 with variable reward policies 164 applied to it) to the user, in the form of a discount at the point of sale. In another example, the user may receive the variable reward not as a discount, but as a reimbursement of funds sent to user funds 160 or an account with payments 150.

At 248, purchase tracking 122 may charge a transacting business a cumulative rewards charge wherein the cumulative rewards charge includes the value of the modified reward and a service charge. As an example, the service charge may be a fee charged by the equity allocation system 120 of loyalty platform 108 for brokering the equity reward. The service charge may be a percentage of the total transaction dollar amount or it may be a flat dollar fee.

At 250, the purchase tracking 122 may request the equity allocation system 120 to issue a buy order with clearing system 104 for equity of the transacting business proportional to the amount of the modified reward. Once clearing system 104 settles the transaction, at step 252, assign module 148 of equity allocation system 120 may update user equity 130 to include the assigned equity. In other words, at 252, the computing system implementing the loyalty platform may perform the step of allocating an amount of the equity reward to the account of the user via an equity allocation system based on the transacting business description matching a description of the business selected by the user in the loyalty selection, the amount of the equity reward further based upon one or more of the transaction amount, a transaction history of the user, and loyalty policies of the business selected by the user and further, transmitting the amount of the equity reward to the user computing device for rendering within a user interface implemented at the user computing device the amount of the equity reward and an updated cumulative balance of the equity reward allocated to the account of the user.

Returning to 232, if the invocation of the random selection algorithm determines that the tracked transaction may not receive a modified reward, then the user may receive a normal reward (without modification) based upon the user rewards 128 of the user account 172, and steps 234-242 are the same as 244-252, where only a normal reward is provided instead.

In an example, a reward which may be given in equity may be stored at user equity 130. In a further example, if a tracked transaction is determined to not receive a modified reward the user may receive the normal reward stored at user rewards 128. The example set forth above and herein may provide incentive for users to repeatedly shop (or increase number of transactions) and spend more money at businesses which they have selected loyalty to as they may unexpectedly receive modified (greater) rewards, in some cases equity rewards. In such an example, users may exhibit increased loyalty to stores where they are occasionally rewarded with greater rewards.

As an example, a reward may comprise at least a purchase discount on a transaction executed with a business the user has selected a loyalty to. As an example, the purchase discount may comprise a dollar amount or a percentage discount on purchases with the transacting business. In a further example, the reward may also include an equity reward. As an example, the reward may further comprise an equity reward which may comprise a percentage of the transaction dollar amount, or in some examples, a set, established dollar amount. In some examples, the equity reward may further comprise a variable percentage of the transaction dollar amount or a variable dollar amount. As an example, a service charge may be a fee charged by loyalty platform 108 for brokering the equity reward, and the service charge may be a percentage of the total transaction dollar amount or it may be a flat dollar fee.

In some examples, the method may include determining a reward based upon any one or any combination of: the loyalty selection, a transaction history of the user, and a variable reward modifier 154. As an example, if the user has not made a loyalty selection to the transacting business, then the user may not receive any reward. If the user has made a loyalty selection to the transacting business, then the user may receive a reward. Furthermore, based upon the loyalty policy (stored in loyalty policies 142) of the transacting business, the reward may be modified based upon a transaction history of the user 132 and/or the reward may be modified based upon a user payment method 134 and/or the reward may be modified based upon the variable reward modifier 154. For example, if a user meets certain criteria based upon past transaction history with the transacting business, then the user may receive a modified award. Furthermore, as an example if a user increases their spending, e.g., the frequency of transactions and/or amount of money spent per transaction, the user may receive a greater reward. Furthermore, as an example, if a user decreases his or her spending, the user may receive a lesser reward. In some examples, a modified reward may comprise a modified equity reward percentage wherein the percentage of the transaction monetary value put towards equity rewards is modified based upon transaction history and/or loyalty history. In some examples, a modified reward may comprise an equity reward percentage, as disclosed above, as well as a set amount of equity (either fractional or whole shares). As an example, rules and/or instructions for modifying rewards based upon transaction history or user behavior or user history, as mentioned above, may be included in variable reward policies, and these modifications may not depend upon the invocation of the random selection algorithm 162.

As a further example, if a user uses a particular credit card or particular payment method, which may be promoted or preferred with respect to the transacting business, then the user may receive a modified reward based upon a modification policy applying, wherein the modification policy applies a reward modifier to the reward based upon the payment method used for the transaction. Furthermore, the reward may be further modified by the variable reward modifier 154, then the reward may be provided to the user and added to one or more of user equity 130 and user funds 160.

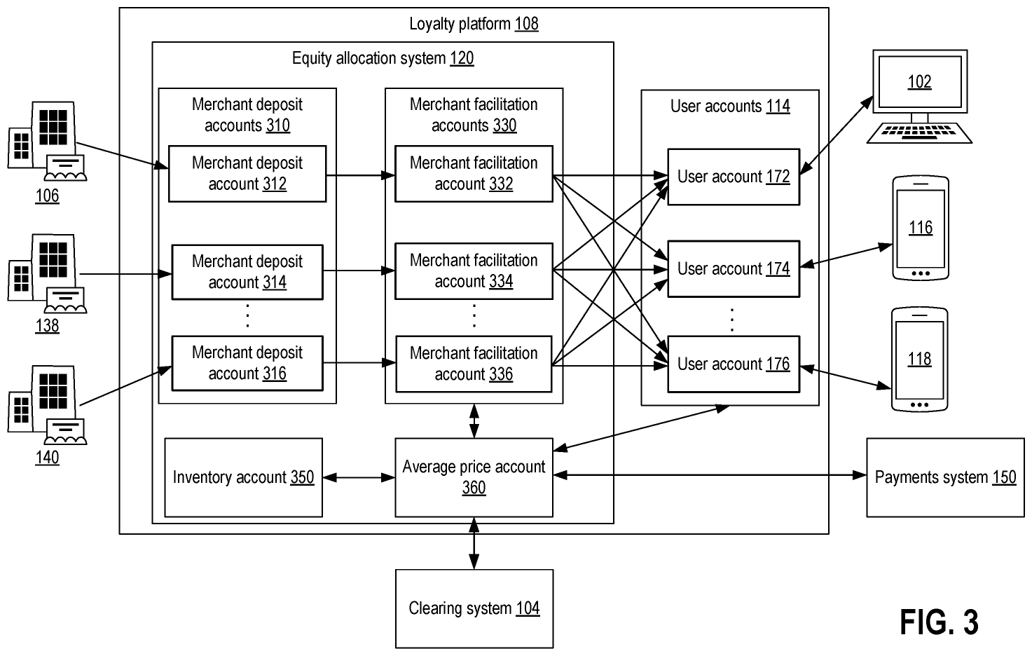

FIG. 3 shows equity allocation system 120, which represents one exemplary embodiment of a system for acquiring, aggregating, distributing, liquidating, and otherwise managing fractional equity rewards on a loyalty platform, such as loyalty platform 108. Elements of FIG. 3 which were previously illustrated and described above with respect to FIGS. 1A and 1B shall retain their numbering in FIG. 3. Although the accounts within equity allocation system 120, as discussed herein, are included within loyalty platform 108, it will be appreciated that such accounts may be held or maintained by a third party without departing from the scope of the current disclosure. In one example, the accounts discussed with reference to FIG. 3 may be maintained by a brokerage firm on behalf of a loyalty platform. In another example, the loyalty platform may operate and/or maintain the accounts discussed with reference to FIG. 3. In the case that the accounts within equity allocation system 120 are operated by a third party brokerage firm, equity allocation system 120 may electronically communicate with one or more of the accounts via a network to enable one or more of the steps or actions described herein with reference to said accounts.

The accounts discussed with reference to FIG. 3 may comprise instructions stored in non-transitory memory of a computing system, such as a computing system implementing loyalty platform 108, wherein the instructions enable the accounts to hold, trade, buy, and sell securities. In one example the securities may comprise shares of stock in a business. In another example the securities may comprise other kinds of securities, such as one or more of government bonds, municipal bonds, mutual funds, futures options, and stock options. In another example, the accounts discussed with reference to FIG. 3 may be configured to buy, sell, trade, hold, or otherwise interact with, crypto assets, such as cryptocurrency, tokens, smart contracts, etc. In one example, the accounts discussed with reference to FIG. 3, such as average price account 360 may be configured to hold, trade, buy, and sell shares of stock in publicly traded businesses. The accounts discussed with reference to FIG. 3 may also be configured to send and receive funds (fiat currency, such as USD) to one or more other accounts, such as, but not limited to, other accounts discussed with reference to FIG. 3. In one example, merchant facilitation account 332 may send an amount of USD to the average price account 360 in exchange for an amount of a security, such as a share of stock. Equity allocation system 120 is shown accompanied by various interacting systems, such as user computing systems 102, 116, and 118, businesses 106, 138, and 140, clearing system 104, and payments system 150. Equity allocation system 120 may alone, on in conjunction with other systems herein described, perform one or more steps of methods 200 and/or 400 herein disclosed with respect to FIGS. 2A-2C and 4. Equity allocation system 120 comprises merchant deposit accounts 310, merchant facilitation accounts 330, inventory account 350, and average price account 360.

Merchant deposit accounts 310 may comprise a plurality of merchant deposit accounts, each corresponding to a unique business. As depicted in FIG. 3, merchant deposit accounts 310 comprise merchant deposit account 312, merchant deposit account 314, and merchant deposit account 316, which are associated with business 106, business 138, and business 140, respectively. Although FIG. 3 depicts three merchant deposit accounts, the disclosure will be understood to provide for any number of merchant deposit accounts, each associated uniquely with a business, to facilitate the distribution of fractional equity rewards on behalf of the business. As part of a Merchant Agreement between the loyalty platform and a business seeking to provide fractional equity rewards to loyalty customers via the loyalty platform, a business may agree to maintain a minimum balance of funds within the merchant deposit account associated with that business. The funds within a merchant deposit account may comprise fiat currency, such as USD, or other stable, and highly liquid currencies which may be used to purchase shares of stock. It will be appreciated that the minimum amount of funds to be maintained in each of the plurality of merchant deposit accounts 310 may be determined on a business by business basis and, as such, may be different for each merchant deposit account.

In one example, the minimum balance of funds for a merchant deposit account associated with a business may increase as a running average rate of fractional equity reward distribution for that business increases. For example, if the total amount of fractional equity rewards earned per day by loyalty customers of business A doubles, the minimum amount of funds to be maintained in the merchant deposit account associated with business A may also double. In another example, the minimum amount of funds to be maintained in a merchant deposit account of a business may be based on a predetermined threshold, wherein the threshold is equal to the minimum amount of funds. As another example, a threshold defining the minimum amount of funds to be maintained by a business in an associated merchant deposit account may be determined as a total monetary value of all fractional equity rewards distributed to users on behalf of that business over the previous 10 days. As another example, the methods for determining the minimum amount of funds to be maintained in a merchant deposit account associated with a business and used to provide fractional equity rewards to users on behalf of that business may be adjusted based on an upcoming event, such as a sale, a promotional offer, a holiday (such as black Friday, Christmas, etc.), or other foreseeable future events which may influence the amount of fractional equity rewards earned by users.

By maintaining a minimum amount of funds within each of the plurality of merchant deposit accounts 310, a probability of interruption/delay in the distribution of fractional equity rewards to users, such as may occur if the balance of a merchant deposit account reaches zero, is reduced. Further, by basing the minimum amount of funds to be maintained in each of the merchant deposit accounts on an individual business basis and on a running average rate of fractional equity reward distribution for each business, a balance may be struck between minimizing the amount of capital a business needs to commit for a reward program and reducing the probability that a fractional equity reward earned by a user may be delayed.

Each of the plurality of merchant deposit accounts in merchant deposit accounts 310 may be uniquely associated with a merchant facilitation account stored in merchant facilitation accounts 330. Said another way, there may be a one-to-one correspondence between each business using the loyalty platform, each merchant deposit account, and each merchant facilitation account. For example, merchant deposit account 312, associated with business 106, may also be associated with merchant facilitation account 332, and may transfer funds to merchant facilitation account 332 to enable the purchase of shares of stock for use as fractional equity rewards for loyalty customers of business 106. Merchant facilitation accounts 330 comprise merchant facilitation account 332, merchant facilitation account 334 (associated with merchant deposit account 314 and business 138), and merchant facilitation account 336 (associated with merchant deposit account 316 and business 140).

Although FIG. 3 shows three merchant facilitation accounts within merchant facilitation accounts 330, it will be appreciated that there may be any number of merchant facilitation accounts stored within merchant facilitation accounts 330. Merchant facilitation accounts 330 may comprise brokerage accounts and thus may be configured to hold both fiat currency and equity. Each of the merchant facilitation accounts stored within merchant facilitation accounts 330 may be configured to communicate with other modules, systems, or components of loyalty platform 108. For example, merchant facilitation accounts 330 may have access to each of the user accounts stored within user accounts 114, which may enable merchant facilitation account to calculate aggregate pending fractional equity rewards owed to these user accounts by one or more of the plurality of merchant facilitation accounts within merchant facilitation accounts 330. In another example, the calculation of pending fractional equity rewards associated with each of the plurality of merchant facilitation accounts may be determined on a per account basis; that is, each of the merchant facilitation accounts may perform an independent calculation of the amount of pending fractional equity rewards it may satisfy. Merchant facilitation accounts 330 may also communicate, that is send and receive data, with merchant deposit accounts 310. In one example, based upon a determination by a merchant facilitation account within merchant facilitation accounts 330, an amount of aggregate pending fractional equity rewards owed by that account to one or more of a plurality of users is greater than a threshold amount, a request may be sent by the merchant facilitation account to an associated merchant deposit account, requesting a transfer of an amount of funds to meet, or reduce below the threshold, the amount of aggregate pending fractional equity rewards.

Each of the merchant facilitation accounts within merchant facilitation accounts 330 may be configured to send and receive funds and shares of stock. For example, each account within merchant facilitation accounts 330 may be configured to receive funds from merchant deposit accounts 310, transfer funds to the average price account 360, receive shares of stock from the average price account 360, and distribute the received shares of stock amongst a plurality of user accounts. As a specific example, $500 may be transferred from merchant deposit account 314 to merchant facilitation account 334 (by loyalty platform 108 on behalf of business 138), which may then be transferred to the average price account 360 in exchange for $500 worth of equity (purchased by the average price account 360 from an exchange, such as the NYSE). Once the $500 worth of equity is received by merchant facilitation account 334, it may be distributed by merchant facilitation account 334 to a plurality of user accounts stored within user accounts 114, to satisfy pending fractional equity rewards. The $500 worth of equity may comprise an amount of fractional shares of stock or may be a number of whole shares of stock. In the case that the $500 worth of equity comprises a fractional amount of shares of stock, the average price account 360 may round-up the fractional amount of shares of stock to the nearest whole share to enable the buy-order to be executed by a conventional exchange. For example, if the $500 equates to 9.6 shares of stock, the average price account may round-up the 9.6 shares to 10.0 shares, with the 9.6 shares being transferred to merchant facilitation account 334 and the fractional remainder share of 0.4 being transferred from the average price account 360 to inventory account 350. The 9.6 shares (the portion of the whole shares purchased by the average price account 360 using funds received from merchant facilitation account 334) may then be distributed to a plurality of user accounts, such as user account 172, user account 174, and user account 176, to satisfy pending fractional equity rewards associated with those accounts.

Average price account 360 may be configured to conduct whole share buys and sells via clearing system 104. In one example, clearing system 104 may comprise a computing system with instructions for executing buy and sell orders for securities on an open market, such as the NYSE. Average price account 360 may be configured to send and receive both funds and securities to/from one or more of the other accounts discussed with reference to FIG. 3. Average price account 360 may comprise instructions stored in non-transitory memory of a computing system to perform one or more of the functions/steps/methods discussed herein. In one example, average price account 360 may comprise instructions to allocate purchased whole shares of stock within a duration of time from the time of purchase, thereby reducing the balance for a given equity to zero by a pre-determined duration from the time of purchase. In one example the duration of time may be 24 hours. In another example, the duration of time may be 6 hours. In another example, the average price account may comprise instructions to allocate the entirety of acquired/purchased whole shares of stock by a pre-determined time. For example, average price account 360 may be configured with instructions to allocate the entirety of its securities to other accounts of the loyalty platform and/or equity allocation system 120 by market close each day, such that securities are not held by average price account 360 overnight.

Inventory account 350 may purchase fractional remainders of shares from average price account 360 leftover after a first portion of whole shares purchased by the average price account is used to satisfy pending fractional equity rewards, such that the average price account does not hold positions in a security for longer than a duration, wherein the duration may be based on regulatory rules or may actively adjusted to reduce penalties or risk associated with holding securities such as stock. In one example, within a 24 hour period of the average price account 360 executing a whole share purchase via clearing system 104, a first portion of the purchased whole shares (which may comprise a fractional amount of shares) may be transferred to one of the accounts within merchant facilitation accounts 114 (for distribution to users) and a fractional remainder of shares, equal to the difference between the purchased whole shares and the transferred portion of shares may be purchased by the inventory account. In this way, all shares purchased by the average price account 360 may be transferred to other accounts within a duration of time, such that after the duration, the balance of the average price account 360 for the purchased whole shares is zero.

A monetary expense of the fractional remainder of shares purchased by inventory account 350 may be debited from inventory account 350 and credited to average price account 360 in exchange for the fractional remainder of shares. The fractional remainder of shares transferred to the inventory account may generally be less than a single share of stock, which may not be easily sold on conventional markets. The inventors herein have recognized this and have provided approaches which may enable rapid and efficient liquidation/exchange of fractional shares of stock. As an example, the inventory account 350 may aggregate fractional remainders of shares from multiple cycles of fractional equity reward distribution, such that over time, the amount of fractional remainders of shares may exceed a liquidation threshold and a whole number of shares may be sold by inventory account 350. The liquidation threshold may in one example comprise a single share, such that upon exceeding the liquidation threshold a single whole share of equity may be sold via clearing system 104. The liquidation threshold may comprise any positive non-zero amount of equity and may comprise fractional or whole numbers of shares. For example, a liquidation threshold for a stock may comprise 1.0 shares, but may alternatively comprise 5.23 shares, 100.1 shares, 3 shares, etc. As a plurality of different stocks may be used for fractional equity rewards, inventory account 360 may accumulate a plurality of different types of stock and each may have an associated liquidation threshold, wherein each liquidation threshold may be determined for the individual stock, such that a plurality of liquidation thresholds corresponding to the plurality of different stock types may be used.

Upon exceeding the liquidation threshold, the loyalty platform 108 may determine an amount of whole shares of stock for which to place a sell order. The amount of whole shares to be sold may be unique for each stock and may depend on the liquidation threshold. For example, a upon an aggregated amount of fractional remainders of stock, for a given stock, in the inventory account 350 exceeding a liquidation threshold of 1.0 shares, a whole share sell order in the amount of 1.0 shares of stock may be placed, either by inventory account 350, or by the average price account 360 on behalf of the inventory account 350. In another example, upon the aggregated fractional remainders of shares of stock, for a given stock, exceeding a liquidation threshold of 10.5 shares of stock, a whole share sell order in the amount of 2.0 shares of stock may be placed. The whole share sell order of the aggregated fractional remainders of shares may be executed via the average price account 360, such that the amount of whole shares aggregated by the inventory account 350 are transferred to average price account 350 and then sold via clearing system 104 on the open market. Alternatively, the whole share sell order may be executed directly by inventory account 350. Upon fulfillment of the sell order for the amount of whole shares, funds in exchange for the whole shares may be transferred to inventory account 350 and used in subsequent cycles of reward distribution to purchase additional fractional remainders of shares of stock. In this way, funds in the inventory account 350 may change slowly over time, such that an initial amount of funds placed in the inventory account 350 for purchasing fractional remainders of shares may require replenishment with reduced frequency compared to alternative approaches.

In order to enroll in one or more of the loyalty rewards programs described above, a user may first sign up for the loyalty platform, then select businesses (hereinafter, a “business” is to be understood to refer to a business, a merchant, a brand, and/or any other entity that may be associated with a loyalty rewards program) and/or associated loyalty rewards programs for enrollment. A similar process may be used to switch enrollment from one loyalty rewards program to another (e.g., to switch between loyalty rewards programs for different businesses). In some examples, switching loyalty from one business/merchant/brand to a second business/merchant/brand may trigger the loyalty platform to prompt the user to redistribute accumulated rewards from the first business to the second business, according to a method such as method 400 discussed below.

Turning to FIG. 4, a method 400 for redistributing rewards accumulated by a user of a loyalty platform is shown. Method 400 may be implemented by one or more of the above discussed systems, such as computing system 180 shown in FIG. 1B by executing machine readable instructions. Method 400 may enable a user to redistribute an accumulated reward stored in a user reward account of a loyalty platform in substantially a single click, thereby saving the user time and energy, and enabling the user to more easily rebalance a portfolio of accumulated rewards to reflect the user's current values and brand loyalties. In one example, method 400 may enable a user to redistribute an accumulated reward of equity in a first business, to an equivalent cash value of equity in a second business, in response to the user switching loyalty from the first business to the second business and upon indication that the user has selected a selectable interface element (the selectable interface may also be referred to as a redistribution button). In another example, method 400 may enable a user to automatically invest an accumulated monetary award, which may comprise an amount of fiat currency obtained from the sale of other equity held by the user, or which may have been awarded to the user from a merchant as part of a loyalty rewards program. As used herein, the terms rebalance and redistribute may be used interchangeably. Although method 400 may be discussed in terms of a single accumulated reward, and in terms of redistributing the single accumulated reward to equity in a single business, it will be appreciated that method 400 may be used to redistribute a plurality of accumulated rewards to a plurality of shares of stock in a plurality of businesses, or to redistribute a plurality of accumulated rewards to shares of stock in a single business, or to redistribute a single accumulate reward to a plurality of stocks in a plurality of businesses, without departing from the scope of the current disclosure.

In one example, method 400 may be executed by a loyalty platform, such as loyalty platform 108, in response to a user selecting a loyalty-switch offer from a first business's loyalty rewards program to a second business's loyalty rewards program, wherein both the first and the second business provide their respective loyalty rewards programs through the loyalty platform. Upon switching loyalties, the user may wish to redistribute an accumulated reward earned from the first business to one or more other areas/investment vehicles.

For example, a user may be enrolled in a loyalty rewards program for the first business and may have accrued rewards for the first business over time. However, responsive to a change in preferences (e.g., the user has decreased transactions at the first business, increased transactions at the second business, moved to a different location, etc.) and/or responsive to an offer from the second business, the user may request to begin receiving equity rewards based on purchases made at the second business instead of based on purchases made at the first business. Example user interface pages for providing such an option to the user are shown at 500a and 500b of FIGS. 5A and 5B, respectively. For example, as shown in FIG. 5A, the user interface 500a presents a list of current loyalty rewards program enrollments, as well as an indication of other loyalty rewards programs that are available for enrollment (e.g., for a given category of business/market). User interface 500b of FIG. 5B may be presented responsive to a selection to change the loyalty rewards program in the “BURGERS” category from a rewards program of a first business (e.g., “JACK IN THE BOX”) to a rewards program of a second business (e.g., “MCDONALD'S”). User interface 500b includes a confirmation of the requested change (e.g., the requested change may be completed responsive to the user selecting “CONFIRM CHANGE”).

In another example, a user may have accumulated 2.5 shares of stock in business X and upon switching loyalty from business X to business Y, wherein business X and business Y operate in a same market (as defined by the loyalty platform), the user may wish to convert their 2.5 shares of accumulated stock in business X to an equivalent amount of stock in business Y, wherein “an equivalent amount” will be understood to represent an equivalent monetary amount at the time of execution of trading/execution of the buy and/or sell orders. For example, if the 2.5 shares of stock X are priced at $1.0 at the time of execution of a sell order for the 2.5 shares, and the price of stock Y is $2.0 at the time of execution of a buy order for the shares of stock Y, then it would be said that the 2.5 shares of stock X are equivalent to the 1.25 shares of stock Y at a specific point in time (the point in time at which the price of stock Y is $2.0 per share and the price of stock X is $1.0 per share).

In another example, method 400 may be executed by a loyalty platform in response to completion of an equity sell order manually initiated by the user. As a more specific example, a user may select to sell a whole or fractional number of shares of stock A, and in response the loyalty platform may place a sell order of the whole or fractional number of shares of stock A via a clearing system. Upon completion of the sale, proceeds of the sale of the whole or fractional number of shares of stock A may be deposited in a user account of the loyalty platform, wherein the proceeds may be referred to herein as a monetary reward. The loyalty platform may then execute method 400 in order to redistribute the accumulated monetary reward by re-investing the monetary reward in one or more businesses to which the user has made a loyalty selection.

In another example, method 400 may be executed by a loyalty platform in response to one or more business events or corporate actions, such as a merger, acquisition, public offering, removal of the brand from the loyalty program to prevent future rewards, etc. In one example, a user may have a loyalty selection to business Z, and upon acquisition of business Z by business Y, the user may wish to redistribute an accumulated reward obtained via tracked loyalty purchases made with business Z to one or more other equities.

Method 400 beings at 402, where a loyalty platform may control a user interface to present a selectable interface element for redistributing an identified accumulated reward. The user interface may be displayed on a display of a user device, which in some examples may comprise a smartphone, tablet, laptop, desktop computer, gaming device, TV, vehicle entertainment system, etc. The accumulated reward may comprise a reward accumulated by a user through participation in one or more loyalty programs offered by one or more businesses, provided through a loyalty platform, such as those loyalty programs described herein. In one example, the accumulated reward may comprise equity in a first business, accumulated based on purchases made with the first business, wherein the equity may comprise whole or fractional shares of stock in the first business. In another example, the accumulated reward may comprise a monetary reward, which may comprise an amount of fiat currency. In one example, the first business may reward a user with an active loyalty selection to the first business with cash-back rewards based on tracked user purchases. In another example, a user may sell an accumulated amount of equity in the first business and obtain an equivalent amount of currency corresponding to the sale of the equity. Therefore, the identified accumulated reward may comprise equity or a monetary reward.

In one example, at 402 method 400 includes the loyalty platform displaying a current cash balance (the accumulated monetary reward) stored in a user account, such as is shown in FIG. 7A. Turning briefly to FIG. 7A a user interface 700a is shown, which is an exemplary user interface for displaying an accumulated monetary reward to a user, such as may be accumulated directly from a business via a cash-back rewards program, an offer the consumer has elected to accept, or after execution of a sell order for an amount of equity acquired from a business as part of an equity based rewards program. User interface 700a includes transfer button 702a, which upon selection by the user may initiate a transfer of the monetary reward to an account outside of the loyalty platform. In one example, selection of transfer button 702a by a user may initiate transfer of an accumulated monetary reward to a bank account of the user. Interface 700a further includes selectable interface element 704a, which may also be referred to as redistribution button 704a. Selection of redistribution button 704a may cause the loyalty platform to display user interface 700b via a user device, as shown in FIG. 7B.

User interface 700b may include information regarding the redistribution of the monetary reward, such as an indication of how/where the monetary reward will be redistributed, as well as how much of the monetary reward will be allocated to each of the one or more businesses/investments into which the monetary reward is to be redistributed. User interface 700b includes confirmation button 702b, which comprises a selectable interface element for confirming a user's choice to redistribute the indicated monetary reward amongst the one or more indicated businesses/investments/locations listed. In one example, the one or more businesses into which the monetary reward is to be redistributed may have been pre-selected by a user, or may be selected automatically by the loyalty platform based on one or more criteria, such as user's current loyalty selections. In one example, a user may select to redistribute accumulated rewards to a subset of the brands/businesses to which the user is loyal, and user interface 700b may indicate the previously selected subset of brands/businesses as the destination of the accumulated monetary reward. In one example, a user may pre-select a preference to distribute accumulated rewards to a top 10 most frequented brands, wherein the top 10 most frequented brands may be the 10 brands to which the user has an active loyalty selection, and with which the user makes the most purchases (quantified either in terms of purchase frequency, or in terms of dollar amount). User interface 700b also includes cancellation button 704b, which may be configured to return a user to a home screen or other pre-determined interface, without initiating redistribution of the accumulated monetary reward. In other words, selection of cancellation button 704b by a user may cause the loyalty platform to maintain the accumulated monetary reward in an account of the user on the loyalty platform. If the loyalty platform receives an indication that the user has selected confirmation button 702b, the loyalty platform may proceed to display user interface 700c, as shown in FIG. 7C, via the user device.

User interface 700c provides visual confirmation to the user that the redistribution process of the accumulated monetary reward has been initiated, and further, user interface 700c may indicate one or more details of the redistribution process. In the example shown in FIG. 7C, user interface 700c indicates that the accumulated monetary reward is being evenly apportioned amongst the plurality of indicated brands/businesses and used to purchase equal dollar amounts of stock in each of the indicated businesses.

In another example, at 402, method 400 may include controlling a user interface of a user application to present a selectable interface element for rebalancing a loyalty rewards platform account for the user. For example, the selectable interface element may be presented on the confirmation screen of user interface 500b of FIG. 5B, as shown at 502. In other examples, the selectable interface element may be presented after a user confirms the request to change loyalty (e.g., the interface element at 502 may be removed from the user interface 500b, and a pop-up window or other interface page may be shown with a similar interface element after the user selects the “Confirm” option).

At 404, the method includes determining whether the user selects the redistribution button/rebalancing interface element. If the user does not select the rebalancing interface element (e.g., “NO” at 404), the method includes maintaining the user's accumulated reward (e.g., the accumulated equity in the first business or the accumulated monetary reward), as indicated at 406. For example, the user's accrued equity in the first business may not be sold unless further input specifically requesting such a sale is received. In another example, a user's accumulated monetary reward may be maintained within an account of the loyalty platform until a user takes further action. The method may then return to wait for further input.

If the user does select the redistribution button/rebalancing interface element (e.g., “YES” at 404), method 400 may proceed to step 408, where the type of accumulated reward is determined. If the accumulated reward does not comprise an equity based reward, such as fractional and/or whole shares of stock in a first business, and instead comprises a monetary reward (e.g., “NO” at 408), method 400 may proceed to calculate an amount of equity in at least a second business that can be purchased with the accumulated monetary reward, as at 410. Method 400 may then proceed to bypass steps 412, 414, and 418 (which are directed to liquidating equity rewards) and proceed directly to step 420, which includes generating buy orders for the calculated amount of equity in the second business.

If the accumulated reward does comprise equity in a first business, (e.g., “YES” at 408), the method includes generating sell orders for identified and marketable equity in the first business, as indicated at 412. For example, marketable equity may refer to equity that is eligible to be sold. For example, where the equity includes shares of stock, marketable equity may include shares which have not been previous sold, but not yet settled, shares which are not in a pending or unsettle status, and/or shares which are not subject to restrictions such as corporate actions that may place a hold on the stock/shares. The generated sell orders may include sell orders for all or a subset of identified and marketable equity in the first business (e.g., all equity in the first business that the user has accrued and that is eligible to be sold), based on user preferences. At 414, the method includes routing the sell orders to an order management process for execution during market hours. For example, as indicated at 416, the method may include queueing orders received outside market hours so that the orders may be executing during a following market period (e.g., at a start of the immediately following market period).

At 418, the method includes, upon execution of the sell orders, determining proceeds of the sale of equity and calculating an amount of equity of the second business that can be purchased with the proceeds. For example, a monetary value of the sale of equity in the first business may be converted to an equivalent amount of equity (e.g., including full and/or partial shares) in the second business based on a current market value of the equity in the first business.

At 420, the method includes generating buy orders for the calculated amount of equity in the second business. As the buy orders may be generated and executed as soon as the sell orders are executed at 418, the buy orders may not be queued for market hours (e.g., since the sell orders are executed during market hours, the buy orders should already be generated during market hours). In this way, the buy orders may be executed as soon as the sell orders are executed, reducing or removing the opportunity for market price changes between selling and buying equity, and avoiding the incomplete or rejected equity investments. In another example, the buy orders may be placed substantially immediately after calculation of the amount of equity of the second business that can be purchased with the accumulated monetary reward, as at 410. After 420, method 400 may proceed to 422.

At 422, the method includes sending a notification to a user that rebalancing has been performed. For example, the notification may be sent upon execution of the buy orders generated at 420. In other examples, notifications may be provided to the user (e.g., via a graphical user interface of a loyalty rewards platform application executed on a user device) throughout the rebalancing process to update the user on the status of the rebalancing.

The above method may also be performed to rebalance the loyalty rewards platform account of a user when the user requests multiple loyalty changes at once (e.g., simultaneously or nearly simultaneously). When multiple loyalty changes are received, the method may provide even further time and user input savings, as one or more portions of the method may be performed simultaneously for multiple loyalty changes. In order to illustrate a multiple loyalty change scenario, the following non-limiting example is provided.

In a first state, a user may have accrued equity in Old Businesses A, B, and C. For example, the user may have accrued 1 share of Business A, valued at $100, 1.5 shares of Business B, valued at $235.50, and 0.5 shares of Business C, valued at $26.30. In a second state, the user may decide to change loyalty from the Old Businesses to respective New Businesses 1, 2, and 3. For example, the user may request to change loyalty (e.g., change enrollment in associated loyalty equity rewards programs) from Business A to Business 1, from Business B to Business 2, and from Business C to Business 3. For example, Businesses A and 1 may be in a first category/market (e.g., home improvement stores), Businesses B and 2 may be in a second category/market (e.g., fast food restaurants), and Businesses C and 3 may be in a third category/market (e.g., coffee shops). The user may indicate the requested loyalty changes via user input to a loyalty rewards platform application.

In a third state, at a “confirm loyalty selections” screen of a user interface in the application and/or responsive to another triggering event, a user interface element (e.g., button) may be presented to offer the choice to automatically sell the full position (e.g., all equity) in each of the Old Businesses A, B, and C and use the complete proceeds of those sales to purchase equity (e.g., full and/or partial shares) in each of the New Businesses 1, 2, and 3. Disclosure language may be presented noting that loyalty rebalancing is done at the request of the user and is not an investment recommendation. If the user selects not to take the offer (e.g., does not press the button, or presses a “NO” or rejection option related to the button), then no action may be taken with regard to current positions/equity for the Old Businesses. In this way, the user may keep the accrued equity in the Old Businesses, but may not accrue any further equity unless the user switches back to being enrolled in respective loyalty programs for the Old Businesses.

If the user selects to take the offer (e.g., presses the button, or presses a “YES” or affirmation option related to the button), then the following actions may be taken:

a. Sell orders are generated for all identified and marketable Old Business equity (e.g., stock positions).

b. The autogenerated sell orders are routed to an order management system for execution during market hours (instructions received outside of market hours will be queued for execution during the following market period).
i. For example, orders are autogenerated to sell 1 share of Business A, market value at $100, 1.5 shares of Business B, market value at $235.50, and 0..5 shares of Business C, market value at $26.30.

c. Upon execution (e.g., trade date) of the autogenerated sell order, the loyalty rewards platform may recognize the proceeds of the sell and calculate the amount of shares of the New Businesses 1, 2, and 3 that can be purchased at the current market prices.

d. Buy orders are generated for equity in New Businesses 1, 2, and 3 (e.g., stock positions).
i. For example, orders are autogenerated to buy: 0.50632 shares of Business 1, market valued at $100, 14.1187 shares of Business 2, market valued at $235.50, and 0.37771 shares of Business 3, market valued at $26.30.

e. Upon execution of the autogenerated buy order, an electronic notification is sent to the user informing the user that the rebalancing has been performed.

The settling of all equity may take time to complete. Accordingly, a fourth state may be entered after loyalty rebalancing, in which orders have been entered and executed to sell the above equity of the Old Businesses and to buy the above equity of the New Businesses (e.g., at time T). Trade confirmations may be made available in the loyalty rewards platform application document center (e.g., at a time T+1). Trades may settle at a time T+2. A fifth state may correspond to the completion of the loyalty rebalancing (e.g., at time T+3). In the fifth state, the equity of the Old Businesses may no longer be in the user's loyalty rewards platform account, and the equity of the New Businesses may be in the user's loyalty rewards platform account and meet the above-described definition of “marketable” (e.g., eligible to be sold).

In the above example, the rebalancing ensures that the same market value of equity is provided for a given pair of Old/New Businesses (e.g., $100 worth of equity in Old Business A is sold, and $100 worth of equity in associated new Business 1 is bought). In other examples, different distributions of equity may be purchased after selling equity in the Old Businesses. For example, $100 worth of equity in Old Business A may be sold, and $50 worth of equity in New Business 1 may be bought, whereby the remaining $50 is used to buy equity in one or both of New Businesses 2 and 3, or cashed out to a linked bank account associated with the user. In some examples, equity may only be purchased for a subset of the New Businesses and not purchased for remaining New Business(es). The distribution of the proceeds from selling equity in Old Businesses (e.g., businesses to which a user is loyal to before changing loyalty/rebalancing; businesses corresponding to rewards programs in which the user is enrolled before changing loyalty/rebalancing) may be selected by a user, predefined according to previously-entered user preferences, selected based on historical market performance of the New Businesses (e.g., businesses to which the user switches loyalty; businesses corresponding to rewards programs in which the user is enrolled after changing loyalty/rebalancing), selected based on prior transactions of the user, and/or based on any other criteria. For example, a percentage of the proceeds from selling the equity of the Old Businesses may be based on a frequency and/or monetary value of transactions performed at each of the associated New Businesses. As a more detailed example, a largest portion of the proceeds may be used to purchase equity in a New Business at which the user has spent the most money within a recent timeframe. Any combination of the above factors may be used to determine an amount of equity to purchase for one or more New Businesses.

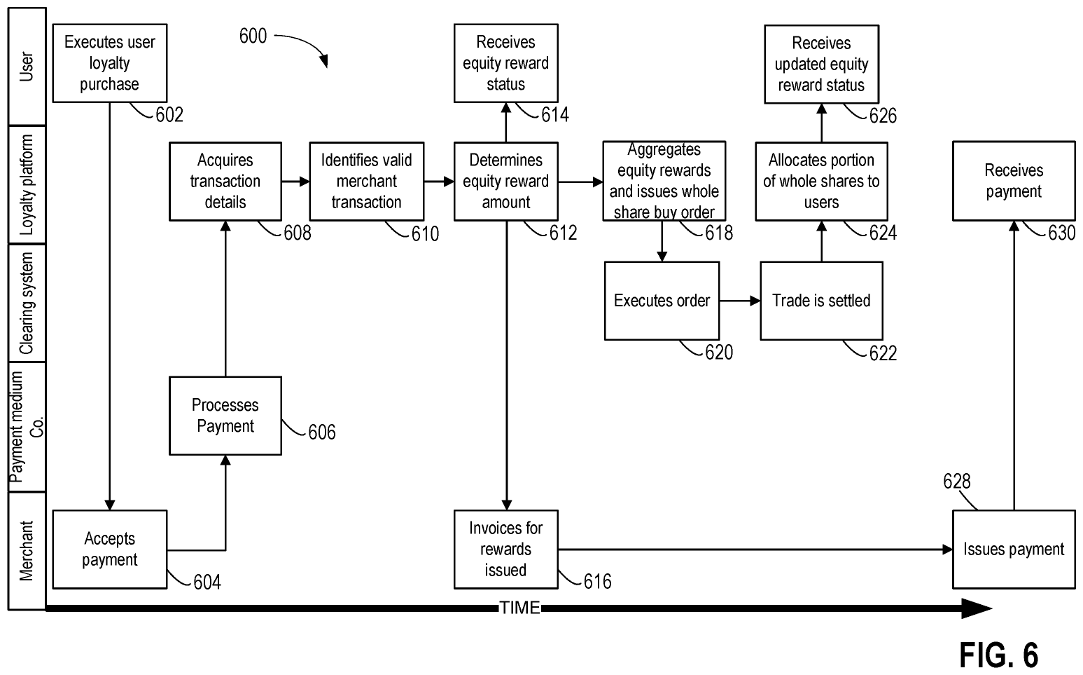

Turning now to FIG. 6 an example method 600 for distributing fractional shares of stock to users of a loyalty platform based on tracked user loyalty purchases is shown. For example, method 600 may be executed in order to distribute rewards to users that have enrolled in associated loyalty rewards programs using method 400 described above with respect to FIG. 4. On the left side of FIG. 6, a column is displayed which indicates what agent/system performs a given step of the method. A step, indicated by a box in the flowchart, horizontally aligned (such as within a same row of a matrix) with an agent/system in the left hand column may be considered to be performed by that agent/system for purposes of example method 600. As a specific example, step 628 of method 600 is horizontally aligned with “Merchant”, which indicates that step 628 is conducted by a business registered with the loyalty platform, which may herein also be referred to as a merchant. Running along the bottom of FIG. 6, is an arrow labeled “TIME”, this arrow indicates the chronology of the steps of method 600, with steps to the right occurring later, steps to the left occurring earlier, and steps vertically aligned occurring substantially concurrently, or within a threshold duration of time of one another. For example, steps aligned vertically may occur within the same 24 hour duration of time.

Method 600 begins at 602, wherein a user executes a user loyalty purchase using a linked payment medium. The linked payment medium may comprise a credit card, debit card, other payment card, cellphone based payment app, NFC based payment system, or other types of electronic payment systems which may provide a digital record of a transaction. Method 600 may then proceed to 602.

Step 602 of method 600 includes the payment being accepted by the merchant. The merchant in this example comprises a business registered with the loyalty platform, and to whom the user (as indicated by the “user” in the left hand column of FIG. 6), has made a loyalty selection (wherein the loyalty selection may be stored in a user account associated with the user on non-transitory memory of one or more computing systems implementing a loyalty platform). Once the user's payment is accepted by the merchant, method 600 may proceed to step 604.

At step 604, method 600 may include the payment medium company processing the payment made during the user loyalty purchase. For example, in the case that the linked payment medium comprises a credit card, step 604 may comprise the credit card company processing the new charge made by the account (the account in this example referring to a user account within the credit card company) to which the user loyalty purchase was charged, and from which funds were obtained to complete the purchase. Processing of the payment may include recording one or more details associated with the user loyalty purchase, such as a date, time, and physical location of the purchase. Once the payment has been processed by the payment medium company, method 600 may proceed to step 606.

At step 606, method 600 includes the loyalty platform receiving transaction details associated with the user loyalty purchase. In one example, a third party data aggregator may compile and transmit purchase details from a plurality of different payment medium companies, such as various banks, credit card companies, etc. In another example, the payment medium company may provide purchase details directly to the loyalty platform. Method 600 may then proceed to step 608.

At step 610, method 600 includes identifying if a valid user loyalty purchase occurred based on the tracked purchase details. In one example, purchase details may be correlated with a database associated with the loyalty platform, such as rewarding-business index 186, to ascertain if the business at which the purchase occurred is registered with the loyalty platform, and currently offering fractional equity rewards to users. Further, step 610 may include looking up a user's loyalty selections, such as by identifying which user account is associated with a tracked purchase (which may be accomplished by determining which account registered a payment medium used to conduct the transaction) and then determining if the user has an active loyalty selection to the business with which the purchase was executed. If at 610 it is determined that a valid user loyalty purchase occurred, method 600 may proceed to step 612.

At step 612, method 600 includes determining/calculating a fractional share amount (a fractional equity reward) to reward the user based on the tracked user loyalty purchase. The determination may be based on a duration of user loyalty selection to the business, a transaction history of the user, a dollar amount (monetary value) of the purchase, and reward policies of the business, stored within the loyalty platform. Once a fractional share amount to reward the user has been determined, method 600 may proceed to step 614.

At step 614, method 600 includes displaying an equity reward status to the user. In one example the equity reward status may include an indication of fractional share amount to which the user is now entitled based on the recently conducted user loyalty purchase, the equity reward status may further include an indication of a timing of distribution of the fractional share amount. Method 600 may then proceed to step 616.

At step 616, method 600 includes invoicing the merchant for the dollar amount of the fractional equity reward, the invoice may further include one or more charges, such as a service fee for the loyalty platform. Method 600 may then proceed to step 628, which includes the merchant issuing a payment to the loyalty platform based on the invoice. At step 630, the loyalty platform may receive the payment from the merchant, and may allocate the received funds. In one example, a portion of the funds may be allocated to a merchant deposit account to provide future rewards of the merchant with fractional equity rewards based on user loyalty purchases.

Returning to step 612, method 600 may also proceed to 618, which includes the loyalty platform aggregating fractional equity rewards and issuing a whole share buy order with a clearing system based on the aggregated rewards. Fractional equity rewards aggregated together may comprise shares of stock in a given business, so that pending fractional equity rewards of stock X are aggregated together into a first aggregate amount, while pending fractional equity rewards of stock Y are aggregated together into a second aggregate amount, but the first and second amounts may not be aggregated together, and no aggregate amount of a mixed stocks may occur. The amount of the whole share buy order may be determined as discussed in more detail above. As one example, the whole share buy order may comprise a number of whole shares within one share of the amount of aggregated fractional equity rewards. As a specific example, based on pending fractional equity reward amount of 2.35 shares of stock X, a whole share buy order of 3.0 shares of stock X may be placed. The 3.0 shares is the rounded-up amount of the aggregated pending fractional equity rewards. Method 600 may then proceed to step 620

At step 620, method 600 includes a clearing system executing the whole share buy order placed in step 618. Method 600 may then proceed to 622. At step 622, method 600 includes the whole share buy order being filled. Method 600 may then proceed to step 624.

At step 624, method 600 includes the loyalty platform receiving from the clearing system the purchased amount of whole shares. The purchased amount of whole shares my deposited within an average price account of the loyalty platform, and may subsequently be allocated to a plurality of users to satisfy pending fractional equity rewards of the plurality of users. This may include first transferring a portion, equal to the aggregated pending fractional equity rewards, from the average price account to a merchant facilitation account, before apportioning the portion in the merchant facilitation account amongst the plurality of users. A fractional remainder of shares leftover after satisfying the pending fractional equity rewards may be purchased by, and stored within, an inventory account of the loyalty platform. Method 600 may then proceed to step 626.

At step 626, method 600 includes displaying an updated equity reward status to a user via a display of a user computing device. The updated equity reward status may indicate that an amount of fractional equity has been transferred to an account associated with the user. The updated equity reward status may further included updated totals for equity held within the account of the user on the loyalty platform. Method 600 may then end.

A technical effect of the disclosed systems and methods is an increase in efficiency and reduction of user input involved in switching one or more loyalty rewards programs for one or more businesses in which a user is enrolled. For example, the disclosed systems and methods may simultaneously coordinate the buying and selling of equity in one or more businesses responsive to the user requesting the switch between loyalty rewards programs.

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property. The terms “including” and “in which” are used as the plain-language equivalents of the respective terms “comprising” and “wherein.” Moreover, the terms “first,” “second,” and “third,” etc. are used merely as labels, and are not intended to impose numerical requirements or a particular positional order on their objects.

This written description uses examples to disclose the invention, including the best mode, and also to enable a person of ordinary skill in the relevant art to practice the invention, including making and using any devices or systems and performing any incorporated methods. The patentable scope of the invention is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A method comprising:
displaying a selectable interface element on a display of a user device, wherein the selectable interface element indicates an accumulated reward from a first business in a rewards account of a user on a loyalty platform, and a least a second business;
responding to selection of the selectable interface element by:
purchasing a first amount of shares of stock in the second business using the accumulated reward from the first business;
storing the first amount of shares of stock in the rewards account of the user on the loyalty platform; and
presenting a notification to the user indicating that redistribution of the accumulated reward has been performed.

2. The method of claim 1, wherein the first amount of shares of stock in the second business is a whole or fractional share of stock in the second business.

3. The method of claim 1, wherein the accumulated reward from the first business comprises a monetary reward, and wherein purchasing the first amount of shares of stock in the second business using the accumulated reward from the first business comprises placing a buy order using a clearing system for the first amount of shares of stock, wherein a value of the first amount of shares of stock is equal to or less than the monetary reward.

4. The method of claim 3, wherein the second business is one of a plurality of businesses indicated by the selectable interface element, and wherein the method further includes responding to selection of the selectable interface element by:
placing a plurality of buy orders with the clearing system for a plurality of amounts of stock in the plurality of businesses.

5. The method of claim 4, wherein the plurality of businesses comprise all businesses to which the user has an active loyalty selection.

6. The method of claim 4, wherein the plurality of businesses comprise a subset of businesses to which the user has an active loyalty selection, wherein the subset of businesses is pre-selected by the user.

7. The method of claim 4, wherein a cumulative monetary value of the plurality of amounts of stock in the plurality of businesses is equal to or less than the monetary reward.

8. The method of claim 4, wherein placing the plurality of buy orders with the clearing system for the plurality of amounts of stock in the plurality of businesses comprises apportioning the monetary reward evenly amongst the plurality of buy orders, wherein each of the plurality of buy orders is of a same monetary value.

9. The method of claim 1, wherein displaying the selectable interface element on the user device is in response to the user switching loyalty from the first business to the second business, wherein the accumulated reward comprises a second amount of shares of stock in the first business, and wherein purchasing the first amount of shares of stock in the second business using the accumulated reward from the first business comprises:
placing a sell order for the second amount of shares of stock using a clearing system;
responding to execution of the sell order by:
determining proceeds obtained from the sell order;
placing a buy order for the first amount of shares of stock in the second business on the clearing system using at least a portion of the proceeds; and
responding to execution of the buy order by allocating the first amount of shares of stock in the second business to the reward account of the user.

10. The method of claim 9, wherein the second amount of shares of stock in the first business comprises a fractional share of stock in the second business.

11. The method of claim 10, wherein placing the sell order for the second amount of shares of stock using the clearing system comprises:
aggregating the fractional share of stock in the first business with one or more additional fractional shares of stock in the first business to form an aggregate amount of shares of stock;
selling the aggregate amount of shares of stock in the first business using the clearing system.

12. A method for rebalancing loyalty rewards, the method comprising:
receiving a request to change enrollment from a first equity rewards program associated with a first business to a second equity rewards program associated with a second business;
removing the user from the first equity rewards program and enrolling the user in the second equity rewards program;
presenting an interface element via a user interface on a display, the interface element being selectable to request a rebalancing of equity in a loyalty rewards platform account of the user; and
responsive to receiving user input selecting the interface element, automatically performing the rebalancing of equity by:
generating one or more sell orders for equity in the first business accrued by the user via the first equity rewards program;
transmitting the one or more sell orders to a clearing system for execution;
upon execution of the one or more sell orders, determining proceeds of an associated sale of the equity in the first business;
calculating an amount of equity in the second business corresponding to the proceeds of the sale of the equity in the first business;
generating buy orders for the calculated amount of equity in the second business; and
presenting a notification to the user that the rebalancing of equity in the loyalty rewards platform account has been performed.

13. The method of claim 12, wherein the first equity rewards program and the second equity rewards program are provided through the loyalty rewards platform, and wherein both the first business and the second business belong to a same market of the loyalty rewards program.

14. The method of claim 12, wherein the calculated amount of equity in the second business is a fractional share of stock associated with the second business.

15. The method of claim 12, the method further comprising, responsive to receiving an indication that the user does not request the rebalancing of equity in the loyalty rewards platform account, maintaining the equity in the first business accrued via the first equity rewards program.

16. The method of claim 12, wherein presenting the interface element via the user interface comprises displaying a single button that is selectable to perform the rebalancing of equity in the loyalty rewards platform account of the user.

17. A computing system, comprising:
a processor;
a display; and
a memory storing instructions executable by the processor to:
receive a request to change enrollment from a first equity rewards program associated with a first business to a second equity rewards program associated with a second business;
remove the user from the first equity rewards program and enrolling the user in the second equity rewards program;
present an interface element via a user interface displayed on a display, the interface element being selectable to request a rebalancing of equity in a loyalty rewards platform account of the user; and
responsive to receiving user input selecting the interface element, automatically perform the rebalancing of equity by:
generating one or more sell orders for equity in the first business accrued by the user via the first equity rewards program;
transmitting the one or more sell orders to a clearing system for execution;
upon execution of the one or more sell orders, determining proceeds of an associated sale of the equity in the first business;
calculating an amount of equity in the second business corresponding to the proceeds of the sale of the equity in the first business;
generating buy orders for the calculated amount of equity in the second business; and
presenting a notification to the user that the rebalancing of equity in the loyalty rewards platform account has been performed.

18. The computing system of claim 17, wherein the instructions are further executable to:
receive information defining a financial transaction between the user and the second business;
based upon a value of the financial transaction, determine an equity reward for the user;
provide the equity reward to the user; and
display the equity reward to the user via the display.

19. The computing system of claim 17, wherein both the first business and the second business are included within a rewarding business index stored in the memory of the computing system, and wherein the rewarding business index indicates both the first business and the second business operate within a same market.

20. The computing system of claim 17, wherein calculating the amount of equity in the second business corresponding to the proceeds of the sale of the equity in the first business further comprises calculating a plurality of amounts of equity in a plurality of businesses based on the proceeds, wherein the second business is one of the plurality of businesses, and wherein the user has an active loyalty selection to each of the plurality of businesses, and wherein generating buy orders for the calculated amount of equity in the second business further comprises generating buy orders for each of the plurality of amounts of equity in the plurality of businesses.
